(19) United States
(12) Patent Application Publication
(10) Pub. No.: US 2010/0070263 A1
(43) Pub. Date: Mar. 18, 2010

(54) SPEECH DATA RETRIEVING WEB SITE SYSTEM

(75) Inventors: Masataka Goto, Ibaraki (JP); Jun Ogata, Ibaraki (JP); Kouichirou Eto, Ibaraki (JP)

Correspondence Address: RANKIN, HILL & CLARK LLP, 38210 Glenn Avenue, WILLOUGHBY, OH, 44094-7808, US

(73) Assignee: NATIONAL INSTITUTE OF ADVANCED INDUSTRIAL SCIENCE AND TECHNOLOGY, Chiyoda-ku ,Tokyo (JP)

(21) Appl. No.: 12/516,883

(22) PCT Filed: Nov. 30, 2007
(86) PCT No.: PCT/JP2007/073211

§ 371 Date: Aug. 20, 2009

(30) Foreign Application Priority Data
Nov. 30, 2006 (JP) 2006-324499

(51) Int. Cl. G06F 17/20; G10L 15/26

(52) U.S. Cl. 704/8; 704/235; 704/E15.043

(57) ABSTRACT

A speech data retrieving Web site system is provided which may improve erroneous indexing with participation of a user by allowing the user to correct text data obtained by conversion using a speech recognition technique. Speech data published on a Web is converted into text data by a speech recognition section 5. A text data publishing section 11 publishes the text data obtained by conversion of the speech data in a state searchable by a search engine, downloadable together with related information corresponding to the text data, and correctable. A text data correcting section 9 corrects the text data stored in a text data storage section 7, according to a correction result registration request supplied from a user terminal device 15 through the Internet.

### TECHNICAL FIELD

The present invention relates to a speech retrieving Web site system that allows retrieval of desired speech data from among a plurality of speech data accessible through the Internet, using a text data search engine, a program for implementing this system using a computer, and a method of constructing and managing the speech data retrieving Web site system.

### BACKGROUND ART

It is difficult to retrieve a desired speech file from speech files (files including speech data) on a Web. It is because extraction of index information (such as a sentence or a keyword) necessary for the retrieval from a speech is difficult. On the other hand, text retrieval has already been put into wide use. Full-text retrieval of various files including texts on the Web has been enabled by an excellent search engine such as Google (trade mark). If a text including the speech context of a speech file on the Web can be extracted, full-text retrieval of the speech file may be likewise performed. However, when speech recognition is performed on various contents to convert the various contents into a text, a recognition rate of the contents is reduced. For this reason, even if a lot of speech files are published on the Web, it is difficult to perform full-text retrieval that provides pinpoint access to a speech including a specific query word.

However, “podcasts”, which may also be referred to as audio versions of blogs (Weblogs), have come into wide use in recent years. Then, a lot of the podcasts have been published as speech files on the Web. As a result, “Podscope (trade mark)” (Non-patent Document 1), “PodZinger (trade mark)” (Non-patent Document 2), which are systems that allow full-text retrieval of a Podcast in English using speech recognition, have been published since 2005.

Non-patent Document 1: http://www.podscope.com/
Non-patent Document 2: http://www.Podzinger.com/

### DISCLOSURE OF THE INVENTION

### Problems to be Solved by the Invention

Both of “Podscope (trademark)” (Non-patent Document 1), and “PodZinger (trademark)” (Non-patent Document 2) hold index information that have been converted into texts using speech recognition, in their inside. Then, a list of podcasts including a query word supplied from a user on a Web browser is presented. In the Podscope (trademark), only podcast titles are listed, and a speech file can be reproduced from a position immediately before occurrence of a query word. However, no text obtained by the speech recognition is displayed. On the other hand, in PodZinger (trademark), portions (speech recognition results) of a text before and after occurrence of a query word are also displayed, thereby allowing the user to more efficiently grasp the partial content of the text. However, even if the speech recognition is performed, the text put into display is limited to a portion of the text. Thus, the detailed content of a podcast cannot be visually grasped without listening to a speech.

Further, a recognition error cannot be avoided in speech recognition. For this reason, when podcasts are erroneously indexed, retrieval of a speech file is adversely affected. Nevertheless, it has been impossible for the user to find out or improve the erroneous indexing.

An object of the present invention is to provide a speech data retrieving Web site system that may improve erroneous indexing with participation of a user by allowing the user to correct text data obtained by conversion using a speech recognition technique.

Another object of the present invention is to provide a speech data retrieving Web site system that allows a user to see full-text data of speech data.

Another object of the present invention is to provide a speech data retrieving Web site system capable of preventing text data from being maliciously tampered.

Another object of the present invention is to provide a speech data retrieving Web site system that allows display of one or more competitive candidates for a word in text data on a display screen of a user terminal device.

Another object of the present invention is to provide a speech data retrieving Web site system that allows display of a position where speech data is reproduced on text data displayed on a display screen of a user terminal device.

Further another object of the present invention is to provide a speech data retrieving Web site system capable of enhancing the performance of speech recognition by using an appropriate speech recognizer according to the content of speech data.

Still another object of the present invention is to provide a speech data retrieving Web site system capable of motivating a user to make correction.

Another object of the present invention is to provide a program used for implementing a speech data retrieving Web site system by a computer.

Another object of the present invention is to provide a method of constructing and managing a speech data retrieving Web site system.

### Means for Solving the Problems

The present invention targets a speech data retrieving Web site system that allows retrieval of desired speech data from among a plurality of speech data accessible through the Internet, using a text data search engine. The present invention further targets a program used when this system is implemented by a computer and a method of constructing and managing this system. Any speech data that can be obtained from a Web through the Internet may be herein used as the speech data. The speech data may include speech data published together with video data. The speech data may include speech data which has music or noise in its background or speech data with music or noise removed therefrom. The search engine may be the one created specifically for this system as well as a common search engine such as Google (trade mark).

The speech data retrieving Web site system of the present invention comprises: a speech data collecting section; a speech data storage section; a speech recognition section; a text data storage section; a text data correcting section; and a text data publishing section. The program of the present invention is installed in the computer and causes the computer to function as the respective sections. The program of the present invention may be recorded on a recording medium readable by the computer.

The speech data collecting section collects the plurality of speech data and a plurality of related information respectively accompanying the plurality of speech data and including at least URLs (Uniform Resource Locators) through the Internet. The speech data storage section stores the plurality of speech data and the plurality of related information collected by the speech data collecting section. As the speech data collecting section, a collecting section generally referred to as a Web crawler may be employed. The Web crawler is a generic name for a program that collects any Web page all over the world in order to create a search database for a full-text search type search engine. The related information may include titles and abstracts accompanying the speech data currently available on the Web as well as the URLs

The speech recognition section converts the plurality of speech data collected by the speech data collecting section into a plurality of text data using a speech recognition technique. As the speech recognition technique, various known speech recognition technique may be employed. A large vocabulary continuous speech recognizer (refer to Japanese Patent Publication No. 2006-146008) capable of generating competitive candidates with confidence scores (by confusion network that will be described later), which was developed by inventors of the present invention and the like, may be used in order to facilitate correction of the text data.

The text data storage section associates and stores the plurality of related information accompanying the plurality of speech data and the plurality of text data corresponding to the plurality of speech data. The text data storage section may be of course configured to separately store the related information and the plurality of speech data.

In the present invention, the text data correcting section in particular corrects the text data stored in the text data storage section according to a correction result registration request supplied through the Internet. The correction result registration request is a command to request registration of a result of text data correction, prepared at a user terminal device. This correction result registration request may be prepared in a format that requests modified text data including a corrected region be interchanged (replaced) with the text data stored in the text data storage section, for example. This correction result registration request may also be prepared in a format that individually specifies a corrected region and a corrected content in the stored text data and requests registration of correction. A program for preparing the correction result registration request may be installed at the user terminal device in advance in order to readily prepare the correction result registration request. When downloaded text data is accompanied by a program for correction, necessary for correcting the text data, a user may prepare the correction result registration request without being particularly conscious of preparing the correction result registration.

The text data publishing section publishes the plurality of text data stored in the text data storage portion in a state searchable by the search engine, downloadable together with the plurality of related information corresponding to the plurality of text data, and correctable. The text data publishing portion allows free access to the plurality of text data through the Internet. Downloading of the text data to the user terminal device may be implemented by constructing a Web site using a common method. Publishing in the correctable state may be achieved by constructing the Web site so that the correction result registration request is accepted.

The present invention allows correction of the text data obtained by conversion of the speech data using the speech recognition technique, according to the correction result registration request from the user terminal device (client) after having published the text data in the correctable state. As a result, according to the present invention, any word included in the text data resulting from the conversion of the speech data may be used as a query word. Speech data retrieval using the search engine is thereby facilitated. With this arrangement, when the user performs full-text retrieval on the text search engine, a podcast including speech data having the query word may also be found, together with an ordinary Web page. As a result, podcasts including a lot of speech data are spread among a lot of users, and the convenience and value of the podcasts are thereby increased. Transmission of information through the podcasts may be therefore further promoted.

Further, according to the present invention, an opportunity to correct a speech recognition error included in the text data by a common user is provided. Then, even when a large amount of speech data is converted into text data by speech recognition and is then published, a speech recognition error may be corrected by user cooperation without spending enormous expense for correction. As a result, according to the present invention, even when the text data obtained by the speech recognition technique is used, the accuracy of retrieval of the speech data may be increased. The function of allowing correction of text data may be referred to as an editing function or “annotation”. The annotation is herein performed in such a way that an accurate transcription text may be prepared and a recognition error in a speech recognition result is corrected, in the system of the present invention. The result of correction (result of editing) by the user is stored in the text data storage section and is used for subsequent retrieval and browsing functions. The result of correction may be used for retraining for improving performance of the speech recognition section.

The system of the present invention may comprise a retrieval section, thereby providing an original retrieval function. Further, the program of the present invention causes the computer to function as the retrieval section. The retrieval section used in this case has first the function of retrieving from among the plurality of text data stored in the text data storage portion at least one of the text data that satisfies a predetermined condition, based on a query word supplied from the user terminal device through the Internet. Then, the retrieval portion has the function of retrieving from among the plurality of text data stored in the text data storage portion the at least one of the text data that satisfies a predetermined condition, and transmitting to the user terminal device at least a portion of the one or more text data obtained by the retrieval and one or more related information accompanying the one or more text data. The retrieval section may be of course configured to allow retrieval using a competitive candidate as well as the plurality of text data. When the retrieval section like this is provided, speech data may be retrieved with high accuracy by making direct access to the system of the present invention.

The system of the present invention may comprise a browsing section, thereby providing an original browsing function. Further, the program of the present invention may also be configured to cause the computer to function as the browsing section. The browsing section used in this case has the function of retrieving from among the plurality of text data stored in the text data storage section one of the text data requested for browsing and transmitting to the user terminal device at least a portion of the one or more text data obtained by the retrieval, based on a browsing request supplied from the user terminal device through the Internet. When the browsing section like this is provided, the user can “read” as well as “listen to” retrieved podcast speech data. This function is effective when the user desires to grasp content of the speech data even if no environment for speech reproduction is provided. Further, even when a podcast is ordinarily to be reproduced, the user may closely examine whether or not to listen to the podcast in advance, which is convenient. While speech reproduction from a podcast is attractive, the user cannot find whether or not he is interested in the content of the podcast before listening to, because the podcast comprises a speech. Even if the time taken for listening to the podcast is reduced by increasing a reproduction speed, there is a limit. When the “browsing” function is used, a full text may be glanced at before listening to. The user may thereby find whether or not he is interested in the content of the full text, in a short time. As a result, the user may efficiently select the podcast. Further, the user may find which portion in the podcast with a long recording time he is interested in. Even if a speech recognition error is included, presence or absence of such interest of the user may be adequately determined. Effectiveness of this browsing function is therefore high.

The speech recognition section may be arbitrarily configured. The speech recognition section having a function of adding to the text data for displaying competitive candidates that compete with words in the text data, for example, may be used as the speech recognition section. When the speech recognition section like this is used, it is preferable to use the browsing section having a function of transmitting the text data including the competitive candidates so that words may be displayed on a display screen of the user terminal device as having the competitive candidates. When the speech recognition section and browsing section are used, a word in the text data displayed on the display screen of the user terminal device maybe displayed as having one or more competitive candidates. Thus, when the user makes correction, the user may be readily informed that the probability of the word being erroneously recognized is high. By changing the color of the word having the one or more candidates from that of other word, for example, the word may be displayed as having the one or more candidates.

The browsing section having a function of transmitting the text data including the competitive candidates may be used as the browsing section so that the text data including the competitive candidates may be displayed on the display screen of the user terminal device. When the browsing portion like this is used and only if the competitive candidates are displayed on the display screen together with the text data, an operation of correction by the user is greatly facilitated.

Preferably, the text data publishing section is also configured to publish the plurality of text data including the competitive candidates targeted for retrieval. In this case, the speech recognition section should be configured to include a function of performing speech recognition so that the competitive candidates that compete with words in the text data are included in the text data. In other words, preferably, the speech recognition section has the function of adding to the text data the data for displaying the competitive candidates that compete with words in the text data. With this arrangement, the user who has obtained text data through the text data publishing section can also correct the text data, using competitive candidates. Further, since the competitive candidates are also targeted for retrieval, the accuracy of the retrieval may be increased. In this case, when downloaded text data is accompanied by the correction program necessary for correcting the text data, the user may readily make correction.

Correction may be maliciously made by the user. Then, preferably, the system of the present invention further comprises a correction determining section that determines whether or not a corrected content requested by the correction result registration request may be regarded as a proper correction. Further, preferably, the program of the present invention causes the computer to further function as the correction determining section. When the correction determining section is provided, the text data correcting section is configured to reflect only the corrected content that has been regarded as the proper correction by the correction determining section on the correction.

The correction determining section may be arbitrarily configured. The correction determining section may be configured, using a language verification technology, for example. When the language verification technology is used, the correction determining section is constituted from a first sentence score calculator, a second sentence score calculator, and a language verification portion. The first sentence score calculator determines a first sentence score indicating the linguistic likelihood of a corrected word sequence of a predetermined length based on a language model provided in advance. The corrected word sequence includes the corrected content requested by the correction according to the correction result registration request. The second sentence score calculator determines a second sentence score indicating the linguistic likelihood of a word sequence of a predetermined length included in the text data, which corresponds to the corrected word sequence and does not include the corrected content based on the language model provided in advance. Then, the language verification section regards the corrected content to be the proper correction when a difference between the first and second sentence scores is smaller than a predetermined reference value.

Alternatively, the correction determining section may be configured, using an acoustic verification technology. When the acoustic verification technology is used, the correction determining section is constituted from a first acoustic likelihood calculator, a second acoustic likelihood calculator, and an acoustic verification section. The first acoustic likelihood calculator determines a first acoustic likelihood indicating the acoustic likelihood of a first phoneme sequence based on an acoustic model provided in advance and the speech data. The first phoneme sequence results from conversion of a corrected word sequence of a predetermined length including the corrected content requested by the correction according to the correction result registration request. The second acoustic likelihood calculator determines a second acoustic likelihood indicating the acoustic likelihood of a second phoneme sequence based on the acoustic model prepared in advance and the speech data. The second phoneme sequence results from conversion of a word sequence of a predetermined length included in the text data, which corresponds to the corrected word sequence and does not include the corrected content. Then, the acoustic verification portion regards the corrected content to be the proper correction when a difference between the first and second acoustic likelihoods is smaller than a predetermined reference value.

The correction determining section may be of course configured by combining both of the language verification technology and the acoustic verification technology. In this case, determination about correction is first made using the language verification technology. Then, determination about the correction is made for only the text that has been judged to be the proper correction without tampering by the acoustic verification technology. With this arrangement, not only the accuracy of determining tampering is increased, but also text data targeted for acoustic verification which is more complicated than language verification may be reduced. Accordingly, determination about correction may be efficiently made.

An identifier determining section may be further provided at the text data correcting section. The identifier determining section determines whether or not identifier accompanying the correction result registration request matches identifier registered in advance. Then, the text data correcting section corrects the text data, if the identifier determining section receives only the correction result registration request including the identifier that has been determined to match the identifier registered in advance by the identifier determining section. With this arrangement, only the user having the identifier may correct the text data. Correction that will be maliciously made may be greatly reduced.

A correction allowable range determining section may be further provided at the text data correcting portion. The correction allowable range determining section determines a correction allowable range within which correction is allowed, based on identifier accompanying the correction result registration request. Then, the text data correcting section corrects the text data, if the correction allowable range determining section receives only the correction result registration request with the range determined by the correction allowable range determining section. Determination of the correction allowable range herein means that determination of a degree of reflecting a corrected result (degree of accepting the correction). For example, reliability of the user who has requested registration of the corrected result is determined from the identifier. Then, by changing weighting for accepting the correction according to the reliability, the correction allowable range may be changed.

Preferably, a ranking calculating section may be further provided in order to promote interest of the user in correction. The ranking calculating section calculates ranking of text data frequently corrected by the text data correcting section and transmits a result of the calculation to one of the user terminal devices in response to a request from the user terminal device.

The speech recognition section and the browsing section having the following functions are used in order to allow display of a location of the speech data being reproduced on the text data displayed on the display screen of the user. To be more specific, preferably, the speech recognition section has a function of including corresponding time information indicating which word included in the text data to which word segment in the speech data corresponds, when the speech data is converted into the text data. Then, the browsing section may have a function of transmitting the text data including the corresponding time information to the user terminal device so that when the speech data is reproduced on the display screen of the user terminal device, a position where the speech data is being reproduced may be displayed on the text data displayed on the display screen of the user terminal device. In this case, the text data publishing section is so configured as to wholly or partially publish the text data.

The speech data collecting section configured to classify the speech data into a plurality of groups according to the genre of speech data content and to store the classified speech data, may be used in order to increase the accuracy of conversion by the speech recognition section. Then, the speech recognition section which includes a plurality of speech recognizers is used. The plurality of speech recognizers corresponds to the plurality of groups. The speech recognition section performs speech recognition of one of the speech data belonging to one of the groups using one of the speech recognizers corresponding to the one group. With this arrangement, the speech recognizer dedicated to each genre of the speech data is used. Thus, the accuracy of speech recognition may be increased.

The speech data collecting section may be used which is configured to determine speaker types (acoustic closeness between speakers) of the plurality of speech data, classify the plurality of speech data into the determined speaker types, and store the classified speech data, in order to increase the accuracy of conversion by the speech recognition section. Then, the speech recognition section may be used, which comprises a plurality of speech recognizers corresponding to the plurality of speaker types and performs speech recognition of one of the speech data belonging to one of the speaker types, using one of the speech recognizers corresponding to the one speaker type. With this arrangement, the speech recognizer corresponding to each speaker may be used. Thus, the accuracy of speech recognition may be increased.

The speech recognition section may have a function of additionally registering an unknown word and a new pronunciation in a built-in speech recognition dictionary, according to the correction by the text data correcting section. With this arrangement, the more corrections are made, the higher accuracy of the speech recognition dictionary is resulted. In this case, the text data storage section in particular, with a plurality of special text data stored therein, is employed. Browsing, retrieval, and correction of the special text data are permitted for only the user terminal device that transmits identifier registered in advance. Then, the text data correcting portion having a function of permitting the correction of the special text data in response to only a request from the user terminal device that transmits the identifier registered in advance may be used. The retrieval portion having a function of permitting the retrieval of the special text data in response to only the request from the user terminal device that transmits the identifier registered in advance may be used. Then, the browsing portion having a function of permitting the browsing of the special text data in response to only the request from the user terminal device that transmits the identifier registered in advance may be used. With this arrangement, when correction of the special text data is permitted to a specific user alone, speech recognition may be performed by using the speech recognition dictionary that has achieved the higher accuracy through correction by the common user. The speech recognition system having high accuracy may be secretly provided to the specific user alone.

The speech recognition section capable of performing additional registration is configured by comprising: a speech recognition executing section; a data correcting section; a phoneme sequence converting section; a phoneme sequence portion extracting section; a pronunciation determining section; and an additional registration section. The speech recognition executing section converts the speech data into the text data sing the speech recognition dictionary formed by collecting a lot of combinations of word pronunciation data each comprising a word and at least one pronunciation constituted from at least one phoneme for the word. The speech recognition executing section has a function of adding to the text data start time and finish time of a word segment in the speech data corresponding to each word included in the text data.

The data correcting section presents one or more competitive candidates for each word in the text data obtained from the speech recognition executing section. Then, the data correcting section allows correction of a word targeted for correction by selecting a correct word from among the one or more competitive candidates when there is the correct word among the one or more competitive candidates, and allows correction of the word targeted for correction by manual input when there is not the correct word among the one or more competitive candidates.

The phoneme sequence converting section recognizes the speech data in unites of phoneme, thereby converting the recognized speech data into a phoneme sequence composed of a plurality of phonemes. Then, the phoneme sequence converting section has a function of adding to the phoneme sequence a start and a finish time of each phoneme unit in the speech data corresponding to each phoneme included in the phoneme sequence. A known phonetic typewriter may be used as the phoneme sequence converting section.

The phoneme sequence portion extracting section extracts from the phoneme sequence a phoneme sequence portion composed of at least one phoneme existing in a segment corresponding to the word segment of the word corrected by the data correcting portion. The segment extends from the start time to the finish time of the word segment. More specifically, the phoneme sequence portion extracting section extracts from the phoneme sequence the phoneme sequence portion indicating the pronunciation of the corrected word. Then, the pronunciation determining section determines this phoneme sequence portion as a pronunciation for the word corrected by the data correcting section.

The additional registration section combines the corrected word with the pronunciation determined by the pronunciation determining section as new pronunciation data and additionally registers the new pronunciation data in the speech recognition dictionary, if it is determined that the corrected word has not been registered in the speech recognition dictionary, or additionally registers the pronunciation determined by the pronunciation determining section in the speech recognition dictionary as another pronunciation of a registered word that has already registered in the speech recognition dictionary, if it is determined that the corrected word is the registered word.

Assume that the speech recognition section like this is used. Then, when the pronunciation for a word obtained by correction is determined and when it is determined that the word is the unknown word which is not registered in the speech recognition dictionary, the word and the pronunciation are registered in the speech recognition dictionary. As a result, the more corrections are made, the more the number of unknown word registrations in the speech recognition dictionary is increased, thereby increasing the accuracy of speech recognition. When the word obtained by the correction is the already registered word, another pronunciation for the word is registered in the speech recognition dictionary. As a result, when speech recognition is performed again after the correction and a speech of the same pronunciation is input again, the speech can correctly undergo speech recognition. Thus, according to the present invention, a correction result may be utilized for increasing the accuracy of the speech recognition dictionary. Accordingly, the accuracy of speech recognition may be increased more than with a conventional speech recognition technique.

Preferably, before correction of the text data is completed, an uncorrected portion undergoes speech recognition again using an unknown word or a pronunciation newly added to the speech recognition dictionary. Preferably, the speech recognition section is configured to perform again speech recognition of speech data corresponding to an uncorrected portion in the text data that has not been corrected yet whenever the additional registration section performs new additional registration. With this arrangement, immediately after additional registration is performed in the speech recognition dictionary, speech recognition is updated. Then, additional registration may be thereby immediately reflected on the speech recognition. As a result, the accuracy of speech recognition of an uncorrected portion is immediately increased. The number of portions to be modified in the text data may be thereby reduced.

A speaker recognition section that identifies the type of a speaker from the speech data is provided in order to further increase the accuracy of speech recognition. Then, a dictionary selecting section should be provided. The dictionary selecting section selects the speech recognition dictionary corresponding to the type of the speaker identified by the speaker recognition section from among a plurality of the speech recognition dictionaries provided in advance, corresponding to the types of speakers. The dictionary selecting section selects the speech recognition dictionary for use in the speech recognition section. With this arrangement, speech recognition is performed using the speech recognition dictionary corresponding to the speaker. Accordingly, the accuracy of recognition may be further increased.

Likewise, the speech recognition dictionary suitable for the content of speech data may be used. In that case, the system of the present invention may further comprise: a genre identifying section that identifies the genre of the spoken content of the speech data; and a dictionary selecting section that selects the speech recognition dictionary corresponding to the genre identified by the genre identifying section from among a plurality of the speech recognition dictionaries provided in advance, corresponding to a plurality of genres. The dictionary selecting section selects the speech recognition dictionary for use in the speech recognition section.

Preferably, the text data correcting section is configured to correct the text data stored in the text data storage section according to the correction result registration request so that when the text data is displayed on the user terminal device, the display may be made in an indication capable of distinguishing between corrected and uncorrected words. In addition to the distinguishing indication using colors which are different between the corrected and uncorrected words, the distinguishing indication using typefaces which are different between the corrected and uncorrected words may be employed, for example. With this arrangement, the corrected and uncorrected words may be checked at glance. An operation of correction is therefore facilitated. Further, suspension of the correction may also be checked.

Preferably, the speech recognition section has a function of adding to the text data the data for displaying the competitive candidates so that when the text data is displayed on the user terminal device, the display may be made in an indication capable of distinguishing between the words having the competitive candidates and words having no competitive candidates. In this case, the indication of changing brightness or chrominance of the letters of words may be employed as the distinguishing indication, for example. With this arrangement as well, an operation of correction is facilitated.

A method of constructing and managing a speech data retrieving Web site system according to the present invention comprises the steps of: collecting speech data, performing speech recognition, storing text data, correcting the text data, and publishing the text data. In the step of collecting speech data, a plurality of speech data and a plurality of respective related information accompanying the plurality of speech data and including at least URLs are collected through the Internet. In the step of storing the speech data, the plurality of speech data and the plurality of related information collected in the step of collecting speech data are stored in a speech data storage section. In the step of performing speech recognition, the plurality of speech data stored in the speech data storage section are converted into a plurality of text data using a speech recognition technique. In the step of storing the text data, the plurality of related information accompanying the plurality of speech data and the plurality of text data corresponding to the plurality of speech data are associated and stored in a text data storage section. In the step of correcting the text data, the text data stored in the text data storage section is corrected according to a correction result registration request supplied through the Internet. Then, in the step of publishing the text data, the plurality of text data stored in the text data storage section is published in a state searchable by the search engine, downloadable together with the plurality of related information corresponding to the plurality of text data, and correctable.

### BRIEF DESCRIPTION OF THE DRAWINGS

FIG. 1 is a diagram showing functional implementation means (respective sections that implement functions) necessary for implementing an embodiment of the present invention using a computer, in the form of a block diagram.

FIG. 2 is a diagram showing a configuration of hardware used when the embodiment in FIG. 1 is actually implemented.

FIG. 3 is a flowchart showing an algorithm of software used when a Web crawler is implemented using the computer.

FIG. 4 is a diagram showing an algorithm of software that implements a speech recognition status management section.

FIG. 5 is a diagram showing an algorithm of software used when an original retrieval function is implemented by the computer, using a retrieval server.

FIG. 6 is a diagram showing an algorithm of software used when an original browsing function is implemented by the computer, using the retrieval server.

FIG. 7 is a diagram showing an algorithm of software used when a correcting function is implemented by the computer, using the retrieval server.

FIG. 8 is a diagram showing an example of an interface used when a text displayed on a display screen of a user terminal device is corrected.

FIG. 9 is a diagram showing a portion of the text before correction, used for explaining the correcting function.

FIG. 10 is a diagram showing an example of a configuration of a correction determining section.

FIG. 11 is a diagram showing a basic algorithm of software that implements the correction determining section.

FIG. 12 is a diagram showing a detailed algorithm when it is determined whether or not correction is maliciously made, using a language verification technology.

FIG. 13 is a diagram showing a detailed algorithm when it is determined whether or not correction is maliciously made, using an acoustic verification technology.

FIGS. 14A to 14D are diagrams showing computation results used when it is determined whether or not correction is maliciously made, using the acoustic verification technology, and used for explaining examples of simulations of acoustic likelihood computation.

FIG. 15 is a block diagram showing a configuration of a speech recognizer having an additional function.

FIG. 16 is a flowchart showing an example of an algorithm of software used when the speech recognizer in FIG. 15 is implemented by the computer.

FIG. 17 is a diagram used for explaining additional registration of a variation in pronunciation.

FIG. 18 is a diagram used for explaining additional registration of an unknown word.

### BEST MODE FOR CARRYING OUT THE INVENTION

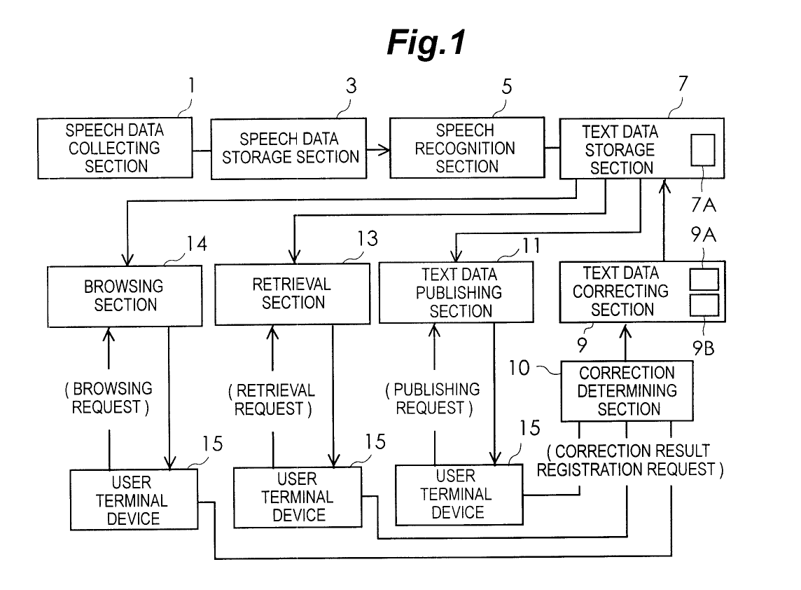

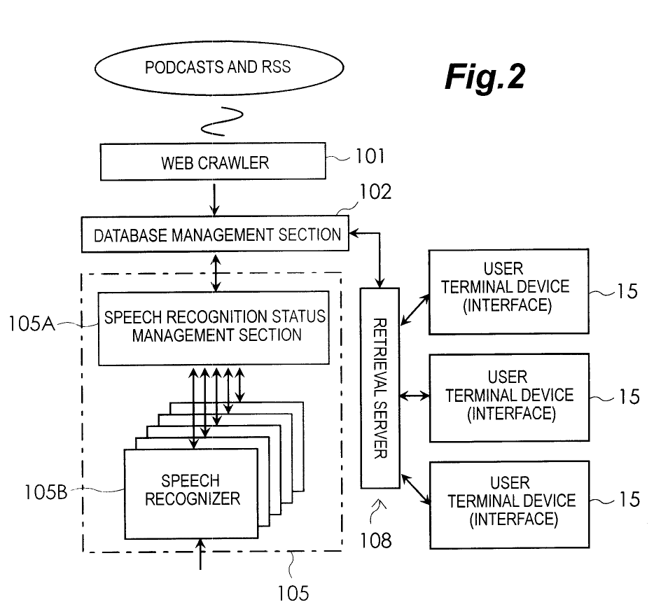

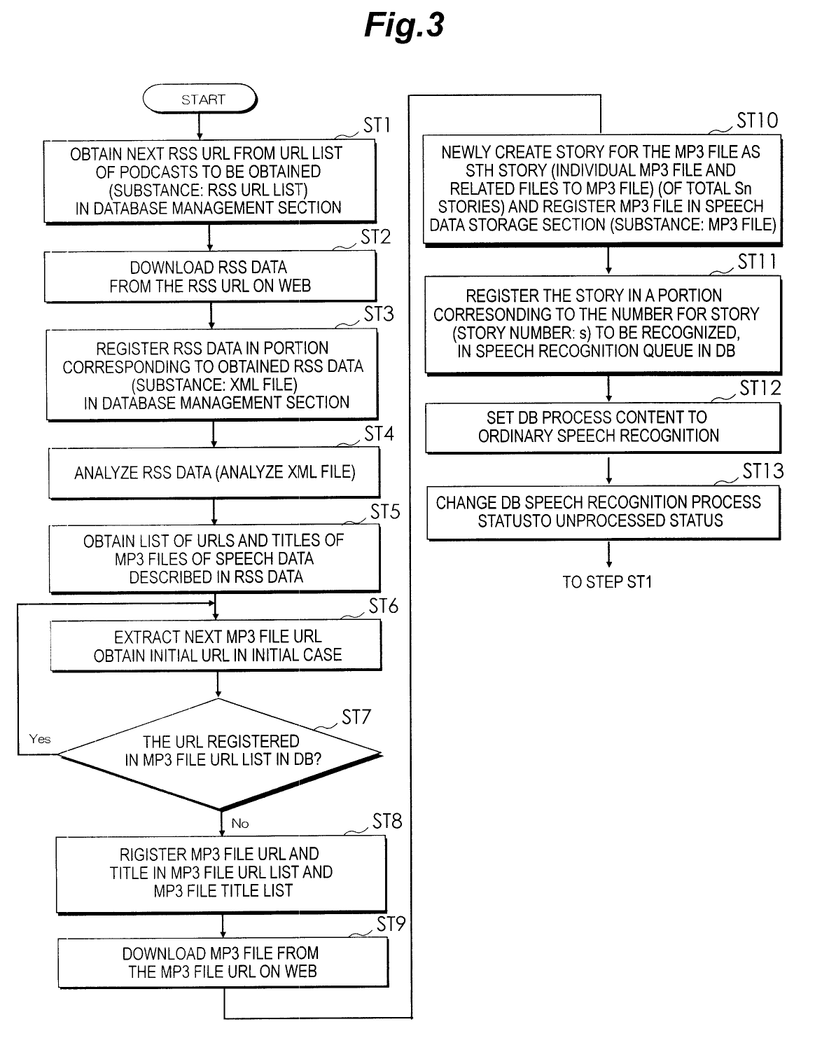

An embodiment of a speech data retrieving Web site system of the present invention, a program used for implementing this system by a computer, and a method of constructing and managing this system will be described below in detail with reference to drawings. FIG. 1 is a diagram showing each portion that implements function needed when the embodiment of the present invention is implemented by the computer, in the form of a block diagram. FIG. 2 is a diagram showing a configuration of hardware used when the embodiment in FIG. 1 is actually implemented. FIGS. 3 through 7 are flowcharts showing algorithms used when the embodiment of the present invention is implemented by the computer.

The speech data retrieving Web site system in the embodiment in FIG. 1 comprises: a speech data collecting section 1 used in a step of collecting speech data; a speech data storage section 3 used in a step of storing the speech data; a speech recognition section 5 used in a step of performing speech recognition; a text data storage section 7 used in a step of storing text data; a text data correcting section 9 used in a step of correcting the text data; a correction determining section 10 used in a step of making determination about the correction, a text data publishing section 11 used in a step of publishing the text data; a retrieval section 13 used in a step of retrieval; and a browsing section 14 used in a step of browsing.

The speech data collecting section 1 collects a plurality of speech data and a plurality of respective related information accompanying the plurality of speech data and including at least URLs (Uniform Resource Locators) through the Internet (in the step of collecting speech data). As the speech data collecting section, a collecting section generally referred to as a Web crawler may be employed. Specifically, a program referred to as the Web crawler, which collects Web pages all over the world, may be employed to configure the speech data collecting section 1, in order to create a retrieval database of a full-text retrieval search engine. Speech data are herein MP3 files in general. Any speech data available on a Web through the Internet may be employed as the speech data. The related information may include titles, abstracts, and the like, in addition to the URLs accompanying the speech data (MP3 files) currently available on the Web.

The speech data storage portion 3 stores the plurality of speech data and the plurality of related information collected by the speech data collecting section 1 (in the step of storing the speech data). This speech data storage section 3 is included in a database management section 102 in FIG. 2.

The speech recognition section 5 converts the plurality of speech data collected by the speech data collecting section 1 into a plurality of text data using a speech recognition technique (in the step of performing speech recognition). In this embodiment, not only an ordinary speech recognition result (of one word sequence) but also a lot of information necessary for reproduction and correction, such as reproduction start and finish times of each word, a plurality of competitive candidates in the segment of the word, and confidence scores are included in text data of the speech recognition result. As the speech recognition technique capable of including such information, various known speech recognition techniques may be employed. In this embodiment in particular, the speech recognition section having a function of adding to the text data for displaying competitive candidates that compete with words in the text data is employed as the speech recognition section 5. Then, this text data is transmitted to a user terminal 15 through the text data publishing section 11, retrieval section 13, and browsing section 14, which will be described later. Specifically, as the speech recognition technique used in the speech recognition section 5, a large vocabulary continuous speech recognizer, which was applied for patent by inventors of the present invention in 2004 and has been already disclosed as Japanese Patent Publication No. 2006-146008 is used. The large vocabulary continuous speech recognizer has a function (confusion network) capable of generating candidates with confidence scores. Details of this speech recognizer are already described in Japanese Patent Publication No. 2006-146008. Thus, a description of this speech recognizer will be omitted.

Assume that the system has a function of transmitting the text data including the candidates is employed. Then, the color of a letter of a word having one or more candidates in the text data displayed on a display screen of the user terminal device 15 may be different from that of other word, for example, so that the word may be displayed as having the one or more candidates. With this arrangement, presence of the one or more candidates for the word may be displayed.

The text data storage portion 7 associates and stores related information accompanying one speech data and text data corresponding to the one speech data (in the step of storing the text data). In this embodiment, the one or more competitive candidates for the word in the text data are also stored, together with the text data. The text data storage section 7 is also included in the database management section 102 in FIG. 2.

The text data correcting sections 9 corrects the text data stored in the text data storage section 7 according to a correction result registration request supplied from the user terminal device (client) 15 through the Internet (in the step of correcting the text data). The correction result registration request is herein a command that requests registration of a text data correction result. The correction result registration request is prepared at the user terminal device 15. This correction result registration request may be prepared in a format that requests modified text data including a corrected region to be interchanged (replaced) with the text data stored in the text data storage section 7. This correction result registration request may also be prepared in a format that individually specifies a corrected region and a corrected content in the stored text data and requests registration of correction.

In this embodiment, as will be described later, the text data to be downloaded is accompanied by a correction program necessary for correcting the text data, and is then transmitted to the user terminal device 15. For this reason, a user may prepare the correction result registration request, without being particularly conscious of preparing the request.

The text data publishing section 11 publishes the plurality of text data stored in the text data storage section 7 in a state retrievable by a known search engine such as Google (trade mark), downloadable together with the plurality of related information corresponding to the plurality of text data, and correctable (in the step of publishing the text data). The text data publishing section 11 allows free access to the plurality of text data through the Internet, and also allows downloading of the text data to the user terminal device 15. Generally, the text data publishing section 11 like this may be implemented by constructing a Web site through which anyone can access the text data storage section 7. Accordingly, the text data publishing section 11 maybe regarded as being actually constituted from means for connecting the Web site to the Internet and the structure of the Web site through which anyone can access the text data storage section 7. Publishment in the state capable of correcting the text data may be achieved by constructing the text data correcting section 9 so that the correction result registration request is accepted.

It is enough to include at least the above-mentioned portions (1, 3, 5, 7, 9, and 11) in order to realize a basic concept of the present invention. In other words, it is enough to arrange that the text data obtained by conversion of the speech data using the speech recognition technique and published in the correctable state may be corrected according to the correction result registration request from the user terminal device 15. With this arrangement, any word included in the text data resulting from the conversion of the speech data may be used as a query word for the search engine. Speech data (MP 3 file) retrieval using the search engine is thereby facilitated. Then, when the user performs full-text retrieval on the text search engine, a podcast including speech data having the query word may also be found, together with an ordinary Web page. As a result, podcasts including a lot of speech data are recognized by a lot of users. Transmission of information through the podcasts may be thereby further promoted.

As will be specifically described later, according to this embodiment, an opportunity to correct a speech recognition error included in the text data by a common user is provided. For this reason, even when a large amount of speech data is converted into text data by speech recognition and is then published, a speech recognition error may be corrected by user cooperation without spending enormous expense for correction. A result (result of edition) obtained by correction by the user is stored in the text data storage section 7 after having been updated (in a mode where text data before the correction is replaced by text data after the correction, for example).

Correction may be maliciously made by the user. Then, this embodiment further comprises a correction determining section 10 that determines whether or not a corrected content requested by the correction result registration request may be regarded as a proper correction. Since the correction determining section 10 is provided, the text data correcting section 9 reflects only the corrected content that has been regarded as the proper correction by the correction determining section 10 on the correction (in the step of making determination about the correction). The configuration of the correction determining section 10 will be specifically described later.

This embodiment further comprises the original retrieval section 13. This original retrieval section 13 has a function of retrieving from among the plurality of text data stored in the text data storage section 7 at least one of the text data that satisfies a predetermined condition, based on a query word supplied from the user terminal device 15 through the Internet (in the step of retrieval). Then, the retrieval section 13 has a function of transmitting to the user terminal device 15 at least a portion of the one or more text data obtained by the retrieval and one or more related information accompanying the one or more text data. When the original retrieval section 13 like this is provided, it may be informed to the user that speech data may be retrieved with high accuracy by making direct access to the system of the present invention.

This embodiment further comprises the original browsing section 14. This original browsing section 14 has a function of retrieving from among the plurality of text data stored in the text data storage section 7 one of the text data requested for browsing and transmitting to the user terminal device 15 at least a portion of the one or more text data obtained by the retrieval, based on a browsing request supplied from the user terminal device 15 through the Internet (in the step of browsing). When the browsing portion like this is provided, the user can “read” as well as “listen to” retrieved podcast speech data. This function is effective when the user desires to grasp the content of the speech data even if no environment for speech reproduction is provided. Further, even when a podcast including speech data is ordinarily to be reproduced, for example, the user may closely examine whether or not he is to listen to the podcast, in advance. Further, when the original browsing section 14 is used, a full text may be glanced at before listening to. The user may thereby find whether or not he is interested in the content of the full text, in a short time. As a result, the user may efficiently select speech data or a podcast.

As the browsing section 14, the browsing portion may be employed, which has a function of transmitting the text data including the competitive candidates so that the text data including the competitive candidates maybe displayed on the display screen of the user terminal device 15. When the browsing section 14 like this is employed, the competitive candidates are displayed on the display screen, together with the text data. An operation of correction by the user is therefore greatly facilitated.

Next, a description will be given about a specific example when this embodiment is carried out using hardware shown in FIG. 2. The hardware shown in FIG. 2 is constituted from a Web crawler 101 that forms the speech data collecting section 1, a database management section 102 in which the speech data storage section 3 and the text data storage section 7 are formed, a speech recognition section 105 that is constituted from a speech recognition status management section 105A, and a plurality of speech recognizers 105B and forms the speech recognition section 5, the text data correcting section 9, the correction determining section 10, the text data publishing section 11, and a retrieval server 108 including the retrieval section 13 and the browsing section 14. A lot of the user terminal devices 15 (such as personal computers, cellular phones, PDAs, and the like) are connected to the retrieval server 108 through the Internet (communication network).

Podcasts (speech data and RSSs) on the Web are collected by the Web crawler (aggregator) 101. The “podcasts” are herein defined to be a cluster of a plurality of speech data (MP3 files) and metadata on the speech data, distributed on the Web. The podcasts are different from just speech data in that metadata RSS (Really Simple Syndication) 2.0 used in a blog or the like for notifying updated information is always added in order to promote speech data distribution. This mechanism causes the podcasts to be also referred to as audio versions of blogs. Accordingly, this embodiment allows full-text retrieval and detailed browsing of a podcast as in the case of text data on the Web. The “RSS” described before is an XML-based format for syndicating and describing the metadata such as a header and an abstract. The title, address, header, abstract, update time, and the like of each page on the Web site are provided in a document described in the RSS format. By using RSS documents, a lot of Web site updated information may be efficiently kept track of, in a standardized way.

One RSS is added to one podcast. Then, a plurality of MP3 file URLs are described in one RSS. Accordingly, a podcast URL in the following description denotes an RSS URL. The RSS is regularly updated by a creator (podcaster). Herein, a group of an individual MP3 file of a podcast and related files (such as a speech recognition result) to the MP3 file is defined as a “story”. When the URL of a new story is added to the podcast, the URL of an old story (MP3 file) is deleted.

The speech data (MP3 files) in the podcasts collected by the Web crawler 101 are stored in a database in the database management section 102. In this embodiment, the database management section 102 stores and manages the following items:

(1) list of URLs of podcasts to be obtained (substance: RSS URL list), which is the URL list of the podcasts to be obtained by the Web crawler 101.

(2) the following items about a kth podcast (of a total of N podcasts):
(2-1) obtained RSS data (substance: XML file)

The number k of RSSs is herein set to k=1 . . . N (in which N is a positive integer).
(2-2) list of URLs of MP3 files

The number s of the URLs is herein set to s=1 . . . Sn (in which Sn is a positive integer). This list is a URL list of Sn stories.
(2-3) lists of related information including the titles of the MP3 files

The number s of the related information lists is herein set to s=1 . . . Sn (in which Sn is the positive integer).

(3) sth story (individual MP3 file and related files to the MP3 file) (of the total Sn stories) of an nth podcast
(3-1) speech data (substance: MP3 file)

This corresponds to the speech data storage section 3 in FIG. 1.
(3-2) list of speech recognition result versions

A number v for a speech recognition result version is set to v=1 . . . V.
(3-3) speech recognition result/correction result of a with version
(3-3-1) data creation date and time
(3-3-2) full text (FText: text including time information on each word)

This corresponds to the text data storage section 7 in FIG. 1.
(3-3-3) confusion network (CNet)

This is a system that presents one or more competitive candidates for each word in order to correct text data.
(3-3-4) speech recognition process status (of speech recognition of obtained speech data indicated as one of the following statuses 1 to 3)

1. unprocessed

2. being processed

3. processed

(4) A number (n) for a podcast for which speech recognition should be performed

(5) correction process queue (queue)
(5-1) A number for a story (story number: s) to be corrected
(5-2) process content
   (1) ordinary speech recognition result
   (2) reflection of correction result
(5-3) correction process status (indicated by one of the following statuses 1 to 3)
   1. unprocessed
   2. being processed
   3. processed

FIG. 3 is a flowchart showing an algorithm of software (program) used when the Web crawler 101 is implemented by the computer. In this flowchart, it is assumed that the following preparation is made. The database management section 102 may be abbreviated as DB in the flowchart in FIG. 3 and the following description.

It is assumed that an RSS URL is first registered firstly in the URL list of the podcasts to be obtained (substance: RSS URL list) in the database management portion 102 as a preparation step, in one of the following cases:

a. when the RSS URL is newly added by the user

b. when the RSS URL is newly added by a manager

c. when RSS URL is regularly and automatically added in order to check whether or not RSS data already stored in the DB is updated to cause an increase in the stories

In step ST1 in FIG. 3, a next RSS URL is obtained from the URL list of the podcasts to be obtained (substance: RSS URL list) in the database management section 102. Then, in step ST2, RSS data is downloaded from the RSS URL. Next, in step ST3, the RSS data is registered in a portion corresponding to the (2-1) obtained RSS data (substance: XML file) in the database management section 102. Then, in step ST4, the RSS data is analyzed (XML file is analyzed). Next, in step ST5, a list of URLs and titles of MP3 files of speech data described in the RSS data is obtained. Next, the following steps ST6 through ST13 are executed with respect to each of the URLs of the MP3 files.

First, in step ST6, a next MP3 file URL is extracted. In an initial case, an initial URL is obtained. Next, the operation proceeds to step ST7. It is determined whether or not the URL is registered in the (2-2) MP3 file URL list in the database management section 102. When the URL is registered, the operation returns to step ST6. When the URL is not registered, the operation proceeds to step ST8. In step ST8, the URL and the title of the MP3 file are registered in the (2-2) MP3 file URL list and the (2-3) MP3 file title list in the database management section 102. Next, in step ST9, the MP3 file is downloaded from the URL of the MP3 file on the Web. Then, the operation proceeds to step ST10, and the story for the MP3 file is newly created as the sth story (individual MP3 file and related files to the MP3 file) of the total S stories in the database (DB) management section 102. The MP3 file is registered in the speech data storage section (substance: MP3 file).

Then, the story is registered in a portion corresponding to the number for the story (story number: s) to be recognized, in a speech recognition queue in the database management section 102. Then, in step ST12, process content of the database management section 102 is set to “1. ordinary speech recognition (no correction)”. Next, in step ST13, the speech recognition process status in the database management section 102 is changed to “1. unprocessed”. In this manner, the speech data and the like in the MP3 files of the speech data described in the RSS data are sequentially stored in the speech data storage section 3.

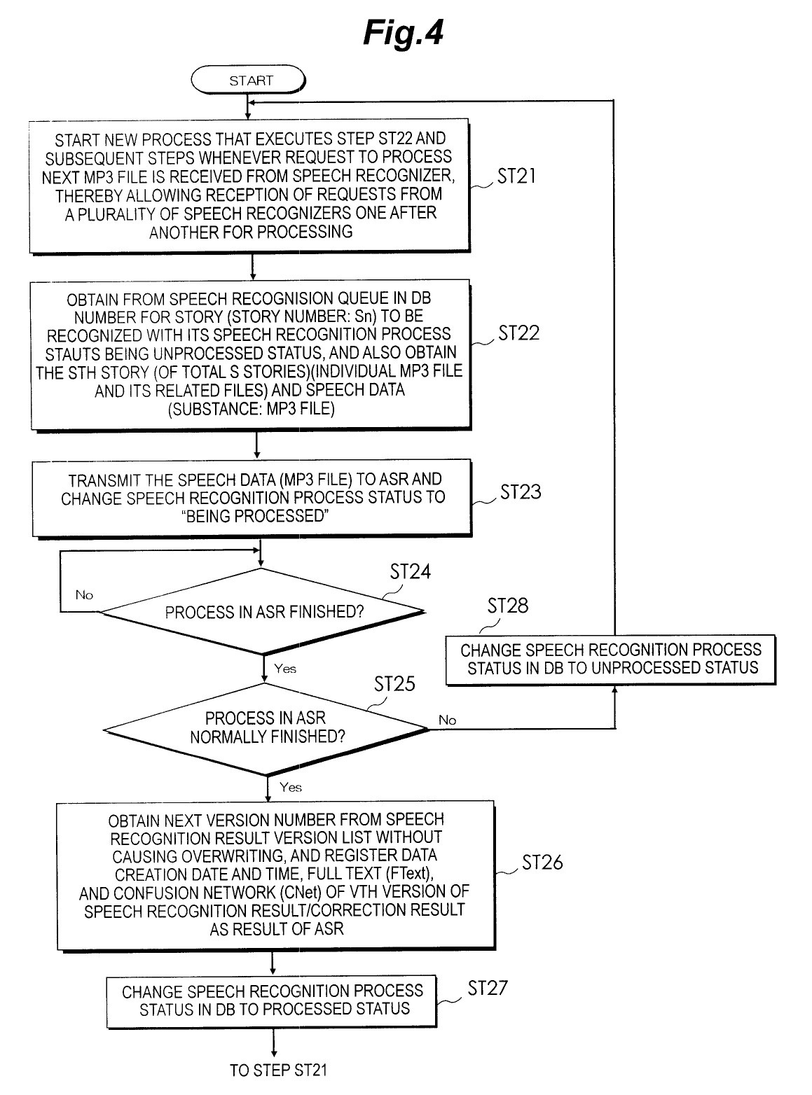

An algorithm of software that implements the speech recognition status management section 105A will be described using FIG. 4. It is assumed in this algorithm that the following operation is performed. When one of the plurality of speech recognizers 105B has surplus processing capability (when the speech recognizer 105B assumes a state capable of performing a next process), the speech recognizer 105B requests next speech data (MP3 file) to the speech recognition status management section 105A. In response to this request, the speech recognition status management section 105A sends the speech data to the speech recognizer 105B that has requested the speech data. Then, the speech recognizer 105B that has received the speech data operates to perform speech recognition of the speech data and send back a result of the speech recognition to the speech recognition status management section 105A. It is assumed such an operation is performed by each of the plurality of speech recognizers 105B. One speech recognizer (on one computer) may perform a plurality of the operations described above in parallel.

First, in the algorithm in FIG. 4, whenever a request to process a next MP3 file is received from the speech recognizer 105B (which may be abbreviated as ASR) firstly in step ST21, a new process that executes step ST22 and subsequent steps is started. Requests from a plurality of the speech recognizers 105B may be thereby received one after another to be processed. In other words, in step ST21, the process is executed by using so-called multi-thread programming. The multi-thread programming is programming in which one program is logically divided into some portions that operate independently and the divided portions are set up to operate in harmony as a whole. In step ST22, the number for a story (story number: s) to be speech-recognized, whose speech recognition process status is “1. unprocessed” is obtained from the speech recognition queue (queue) described before in the database management section 102. Then, the sth story (of the total S stories)(individual MP3 file and related files to the MP3 file) and speech data (whose substance is the MP3 file) are also obtained. Then, in step ST23, the speech data (MP3 file) is transmitted to the speech recognizer 105B (ASR). Further, the speech recognition process status in the database management section 102 is changed to “being processed”, in this step. Next, in step ST 24, it is determined whether or not the process in the speech recognizer 105B is finished. When the process is finished, the operation proceeds to step ST25. When the process is not finished, step ST24 is kept on. In step ST25, it is determined whether or not the process in the speech recognizer 105B has been normally finished. When the process has been normally finished, the operation proceeds to step ST26. In step ST26, a next version number is obtained from the (3-2) speech recognition result version list in the database management section 102 in such a manner that overwriting is not performed. Then, a result obtained from the speech recognizer 105B is registered in a portion corresponding to the speech recognition result/correction result of the (3-3) with version in the database management portion 102. Data on the (3-3-1) data creation date and time, (3-3-2) full text (FText), and (3-3-3) confusion network (CNet) are registered in this step. Then, the operation proceeds to step ST27, where the speech recognition process status is changed to “processed”. Then, when step ST27 is finished, the operation returns to step ST21. Namely, the process that has executed step ST22 and the subsequent is finished. When it is determined in step ST25 that the process has not been normally finished, the operation proceeds to step ST28. In step ST28, the speech recognition process status in the database management section 102 is changed to “unprocessed”. Then, the operation returns to step ST21, thereby finishing the process that executes ST22 and the subsequent steps.

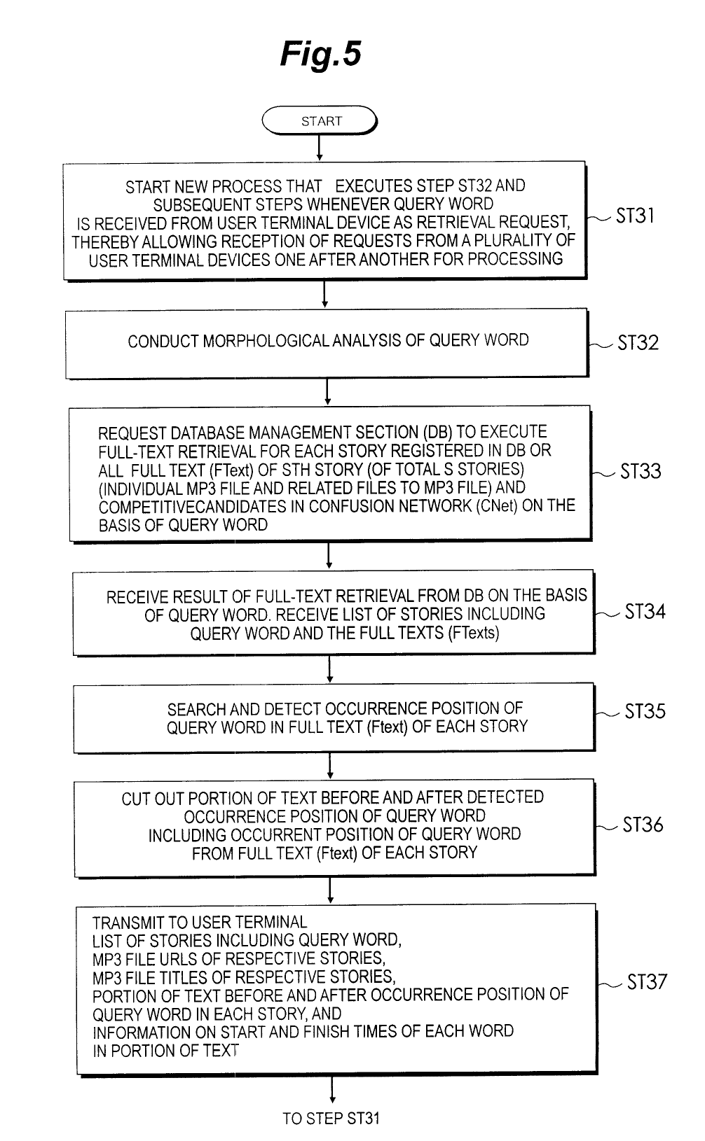

Next, an algorithm of software when the original retrieval function (of the retrieval portion), original browsing function (of the browsing portion), and correcting function (of the correcting portion) are implemented by the computer, using the retrieval server 108 will be explained, by using FIGS. 5 through 7. Since process requests are asynchronously supplied to the retrieval server 108 from the respective user terminals (interfaces) 15 one after another, the retrieval server 108 or a Web server processes those requests. FIG. 5 shows a process algorithm when a retrieval request is supplied from the user terminal 15. In step ST31, the retrieval server 108 receives a query word from the user terminal 15 as the retrieval request. Whenever the query word is received, a new process that executes ST32 and subsequent steps is started. This process is also executed by using the so-called multi-thread programming. Accordingly, the retrieval server 108 may receive requests from a plurality of the terminal devices one after another to process the requests. In step ST32, the retrieval server 108 conducts morphological analysis of the query word. A phoneme is defined to be a minimum character sequence that would have no meaning if divided into smaller units. In the morphological analysis, the query word is broken down into minimum character sequences. A program referred to as a morphological analysis program is used for this analysis. Next, in step ST33, full-text retrieval on the basis of the query word that has undergone the morphological analysis is executed for each story registered in the database management section 102, or the full text (FText) of the sth story (of the total Sn stories)(individual MP3 file and related files to the MP3 file) and competitive candidates in the confusion network (CNet). The retrieval is actually executed at the database management section 102. In step ST34, the retrieval server 108 receives from the database management portion 102 a result of the full-text retrieval on the basis of the query word. The retrieval server 108 further receives a list of the stories including the query word and the full texts (FTexts) of the stories. Then, in step ST35, the occurrence position of the query word in the full text (FText) of each story is searched and detected. Then, in step ST36, a portion of the text before and after the detected occurrence position of the query word including the occurrence position of the query word in the full text (Ftext) of each story is cut out for display on a display section of the user terminal device. In this full text (FText), information on start and finish times of each word in the text is accompanied. Then, the operation proceeds to step ST37, where a list of the stories including the query word, MP3 file URLs of the respective stories, MP3 file titles of the respective stories, the portion of the text before and after the occurrence position of the query word in each story, and information on the start and finish times of each word in the portion of the text are transmitted to the user terminal device 15. A list of the results of the retrieval is displayed on the display screen of the user terminal device 15. Then, the user may reproduce sounds before and after the occurrence position of the query word, or may request browsing of the story, using the MP3 file URLs. When the step ST37 is finished, the operation returns to step ST31. As a result, the process that executes step ST32 and the subsequent steps is finished.

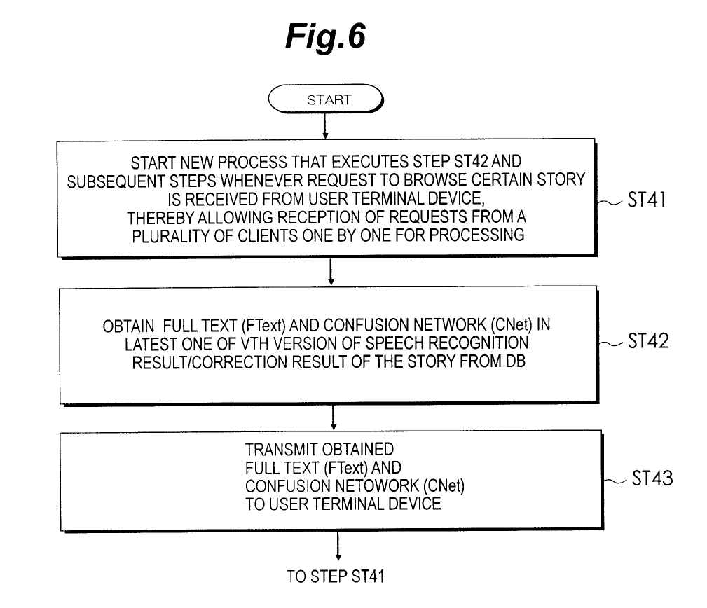

FIG. 6 is a flowchart showing an algorithm of software for implementing the browsing function. In step ST41, whenever a request to browse a certain story is received from the user terminal device 15, a new process that executes step ST42 and subsequent steps is started. In other words, it is arranged that requests from a plurality of the terminal devices 15 may be received one after another to be processed. Next, in step ST42, the retrieval server 108 obtains the full text (FText) and the confusion network (CNet) in a latest one of the with version of the speech recognition result/correction result of the story from the database management portion 102. Then, in step ST43, the retrieval server 108 transmits the obtained full text (FText) and the obtained confusion network (CNet) to the user terminal device 15. The user terminal device 15 displays the obtained full text as the full text of the speech recognition result. Since the confusion network (CNet) is transmitted together with the full text, the user may not only browse the full text but also correct a speech recognition error on the user terminal device 15, as will be described later. When the step ST43 is finished, the operation returns to step ST41. In other words, the process that executes step ST42 and the subsequent steps is finished.

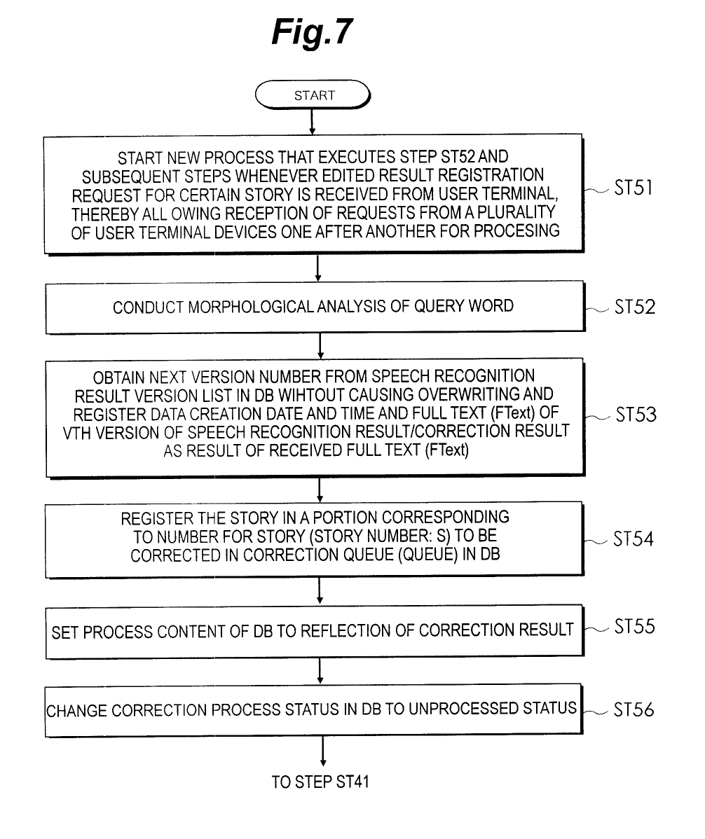

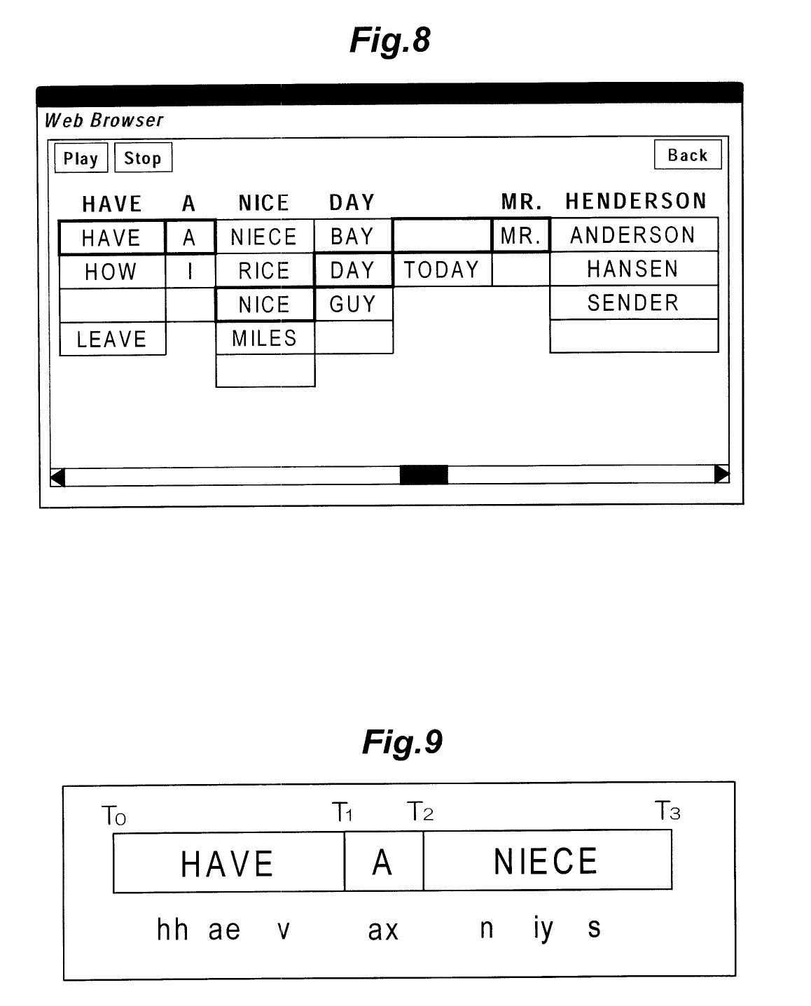

FIG. 7 is a flowchart showing an algorithm of software when the correcting function (of the correcting section) is implemented by the computer. The correction result registration request is output from the user terminal device 15. FIG. 8 shows an example of an interface used for correcting a text displayed on the display screen of the user terminal device 15. In this interface, a portion of text data is displayed together with competitive candidates. The competitive candidates are generated by the confusion network used in the large vocabulary continuous speech recognizer published in Japanese Patent Publication No. 2006-146008.

The example in FIG. 8 shows a state where the correction has already been finished. Competitive candidates displayed by bold frames among the competitive candidates in FIG. 8 are words selected in the correction. FIG. 9 shows a portion of the text before the correction. Characters T₀ and T₂ marked above words “HAVE” and “NIECE” in FIG. 9 indicate reproduction start times of the respective words “HAVE” and “NIECE” when speech data is reproduced. Characters T₁ and T₃ indicate reproduction finish times of the respective words “HAVE” and “NIECE” when the speech data is reproduced. These times just accompany text data, and are not actually displayed on the screen as shown in FIG. 9. When such times are made to accompany text data, speech data may be reproduced from a position of the word when the word is clicked in a reproduction system of the user terminal device 15. Accordingly, ease of use at a time of reproduction is greatly increased on a user side. Assume that a result of speech recognition before correction was “HAVE A NIECE . . . ” as shown in FIG. 9. In this case, when a word “NICE” is selected from among word candidates for the word “NIECE”, the word “NIECE” is replaced by the selected word “NICE”. When competitive candidates are displayed on the display screen in this manner that the competitive candidates are selective, a speech recognition result may be readily corrected. Thus, correction of the speech recognition result may be greatly facilitated, with the cooperation of the user. When a save button is clicked after the correction of the speech recognition error, the correction result registration request is supplied from the user terminal device 15 in order to register a result of the correction (editing). The substance of the correction result registration request is a full text (FText) after the correction. In other words, the correction result registration request is a request to replace full-text data before the correction by full-text data after the correction. Words in the text displayed on the display screen may be of course directly corrected, without presenting the competitive candidates.

Referring back to FIG. 7, in step ST51, the retrieval server 108 receives the correction result registration request for a certain story (speech data) from the user terminal device 15. Whenever the speech data is received, a new process that executes step ST52 and subsequent steps is started. Requests from a plurality of the terminal devices may be thereby received one after another to be processed. In step ST52, the retrieval server 108 conduct morphological analysis of a query word. In step ST53, the retrieval server 108 obtains a next version number from the speech recognition result version list in the database management section 102 in such a manner that overwriting is not performed. After the database management 102 receives the result of the corrected full text (FText) is set to the with version of the speech recognition result/correction result, the full text (FText) to be corrective is registered with its creation date and time. Next, the operation proceeds step ST54. Then, the story is registered in a portion corresponding to the number for the story (story number: s) to be corrected, in the correction queue (queue) in the database management section 102. In other words, the story is registered in the correction queue for making a correction process. Next, in step ST55, content of the correction process is set to “reflection of the correction result”. In step ST56, the correction process status in the database management section 102 is changed to “Unprocessed”. After this status is set, the operation returns to step ST51. In short, the process that has executed step ST52 and the subsequent steps is finished. In the algorithm in FIG. 7, the correction result registration request is received, and then the process is performed up to a state where the correction may be executed. The final correction process is executed at the database management section 102. The correction process is performed on the full text in the “unprocessed” status when its turn in the correction queue is reached. Then, the result of the correction is reflected on the text data stored in the text data storage section 7. When the correction is reflected, the correction process status in the database management section 102 is changed to “Processed”.

In a detailed indication shown in FIG. 8, competitive candidate lists are displayed under respective word segments of the recognition result arranged laterally. This display indication is explained in detail in Japanese Patent Publication No. 2006-146008. Constant display of competitive candidates in this manner saves effort in clicking an error portion to check for the candidates. The error portion may be therefore corrected just by selecting correct words one after another. A portion having a lot of competitive candidates in this display indicates high ambiguity (or lack of accuracy on the side of the speech recognizer) at a time of recognition. Accordingly, when display is made in the detailed indication, an advantage that an error portion is difficult to overlook is obtained because the user makes correction while giving attention to the number of candidates. Further, competitive candidates in each segment are arranged in the descending order of confidence scores. Thus, in most instances, the user can early arrive at a correct word by glancing at the candidates from above to bottom. Because the competitive candidate of each segment is arranged in order of high reliability. Each competitive candidate invariably includes a blank candidate. This blank candidate is referred to as a “deletion candidate”, and serves to omit the recognition result in that segment. In short, by clicking this blank candidate, a portion into which an unnecessary word is inserted may be readily deleted. This deletion candidate is also explained in detail in Japanese Patent Publication No. 2006-146008.

Two types of display indications may be freely switched with a cursor position in the course of correction kept saved. A full-text indication is useful for the user for whom browsing of a text is a main purpose. In the full-text indication, competitive candidates are usually invisible so as not to block user's view. However, when the user has noticed a recognition error, the full-text indication has an advantage that the user may readily correct the recognition error alone. On the other hand, the detailed indication is useful for the user for whom correction of a recognition error is a main purpose. The detailed indication has an advantage that the user may efficiently correct a recognition error with good visibility while seeing competitive candidates and the number of the competitive candidates before and after the competitive candidate of the recognition error.

In the system in this embodiment, a speech recognition result is published to the user in a correctable state, thereby obtaining cooperation for text data correction from the user. In this system, the recognition result may be tampered with by correction by a malicious user. Then, as shown in FIG. 1, this embodiment comprises the correction determining section 10 that determines whether or not a corrected content requested by the correction result registration request may be regarded as a proper correction. Since the correction determining section 10 is provided, the text data correcting section 9 is configured to reflect only the corrected content that has been regarded as the proper correction by the correction determining section 10 on the correction.

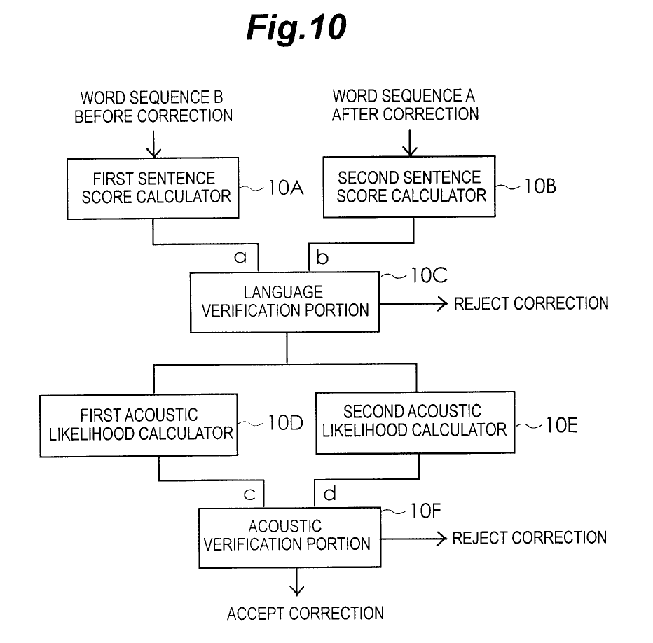

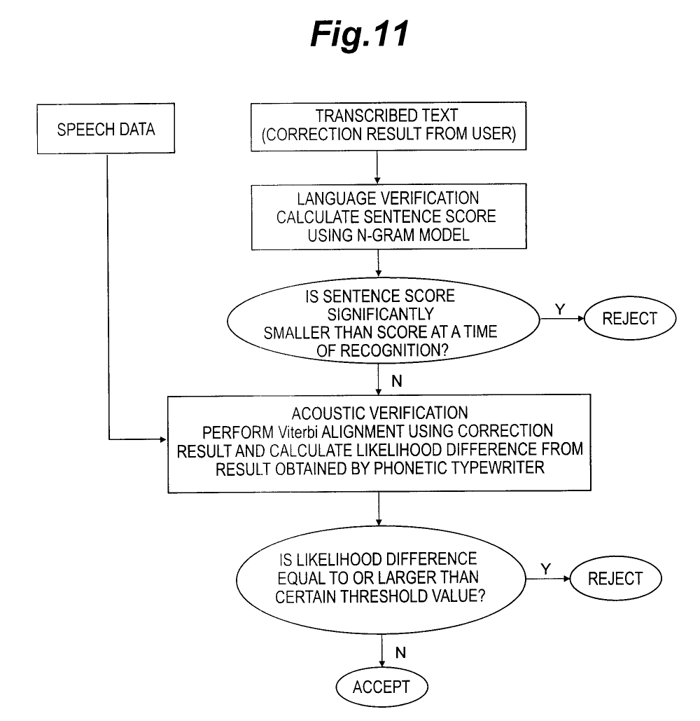

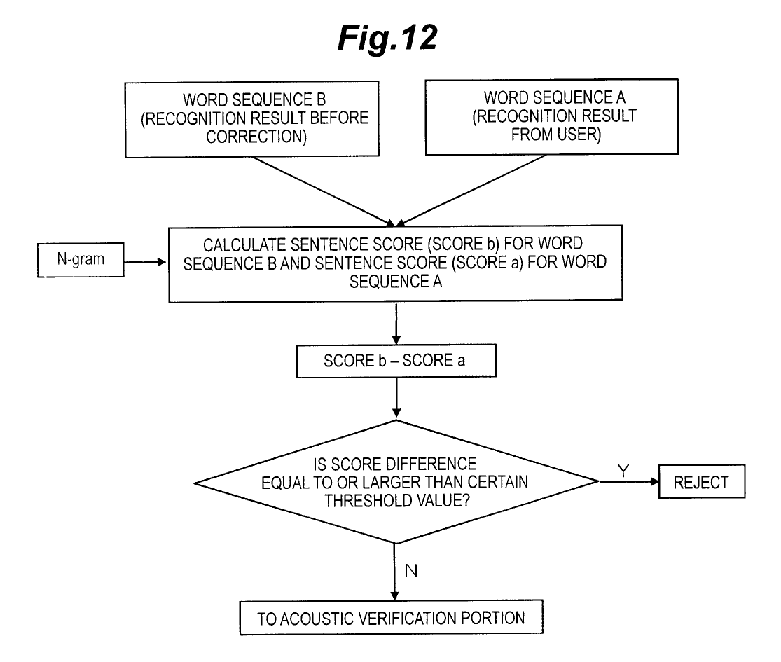

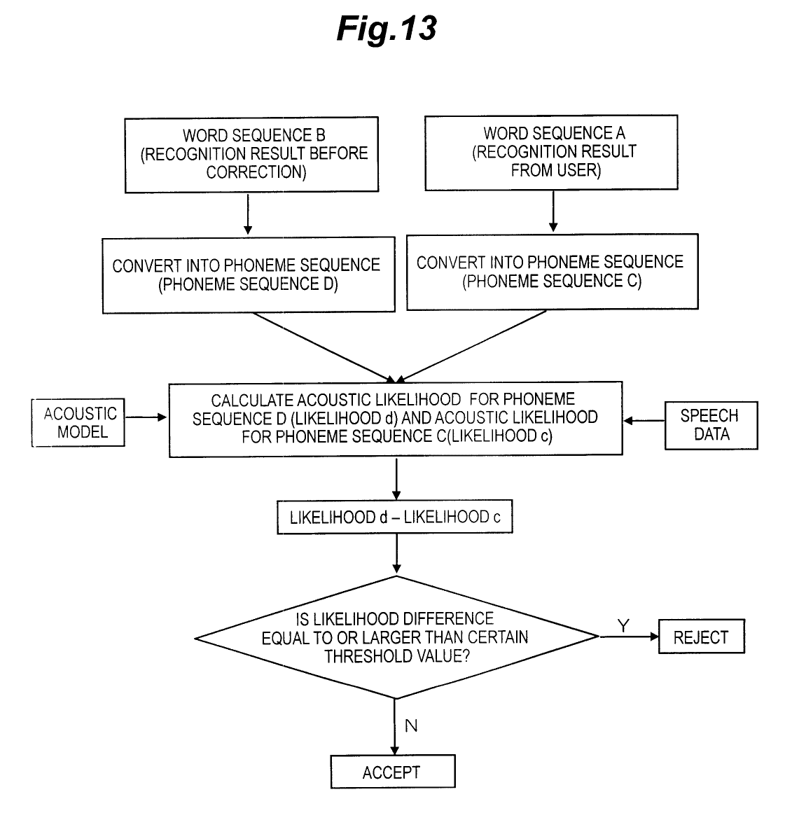

The correction determining section 10 may be arbitrarily configured. In this embodiment, as shown in FIG. 10, the correction determining section 10 is configured by combining a technique that uses a language verification technology with a technique that uses an audio verification technology. Both techniques are used to determine whether or not correction has been maliciously made. FIG. 11 shows a basic algorithm of software that implements the correction determining section 10. FIG. 12 shows a detailed algorithm when the language verification technology is used to determine whether or not correction has been maliciously made. FIG. 13 shows a detailed algorithm when the audio verification technology is used to determine whether or not correction has been maliciously made. As shown in FIG. 10, the correction determining section 10 comprises a first sentence score calculator 10A and a second sentence score calculator 10B, and a language verification section 10C in order to determine whether or not correction has been maliciously made by using the language verification technology. The correction determining section 10 further comprises a first acoustic likelihood calculator 10D and a second acoustic likelihood calculator 10E, and an acoustic verification section 10F in order to determine whether or not the correction has been maliciously made by using the acoustic verification technology.

As shown in FIG. 12, the first sentence score calculator 10A determines a first sentence score a (linguistic connection probability) indicating the linguistic likelihood of a corrected word sequence A of a predetermined length based on a language model provided in advance (herein an N-gram being used). The corrected word sequence A includes a corrected content requested by correction according to the correction result registration request. The second sentence score calculator 10B also determines a second sentence score b (linguistic connection probability) indicating the linguistic likelihood of a word sequence B of a predetermined length included in the text data, which corresponds to the corrected word sequence A and does not include the corrected content, based on the same language model provided in advance. Then, the language verification section 10C regards the corrected content to be a proper correction when a difference (b—a) between the first and second sentence scores is smaller than a predetermined reference value (threshold value). When the difference (b—a) between the first and second sentence scores is equal to or larger than the predetermined reference value (threshold value), the language verification portion 10C regards the corrected content as having been tampered with.

In this embodiment, determination about the speech recognition result (text data) whose corrected content has been determined to be proper by the language verification technology is made again, using the acoustic verification technology. Then, the first acoustic likelihood calculator 10D converts the corrected word sequence A of the predetermined length including the corrected content requested by the correction according to the correction result registration result into a phoneme sequence, thereby obtaining a first phoneme sequence C, as shown in FIG. 13. Further, the first acoustic likelihood calculator 10D generates a phoneme sequence of a speech data portion corresponding to the correction word sequence A from the speech data, using a phonetic typewriter. The first acoustic likelihood calculator 10D performs Viterbi alignment between the phoneme sequence of the speech data portion and the first phoneme sequence using an acoustic model, thereby determining a first acoustic likelihood c.

The second acoustic likelihood calculator 10E determines a second acoustic likelihood d indicating the acoustic likelihood of a second phoneme sequence D. The second phoneme sequence D is obtained by converting the word sequence A of the predetermined length included in the text data, which corresponds to the corrected word sequence B and does not include the corrected content. The second acoustic likelihood calculator 10E performs Viterbi alignment between the phoneme sequence of the speech data portion and the second phoneme sequence using the acoustic model, thereby determining the second acoustic likelihood d. Then, the acoustic verification section 10F regards the corrected content to be the proper correction when a difference (d−c) between the first and second acoustic likelihoods is smaller than a predetermined reference value (threshold value). When the difference (d−c) between the first and second acoustic likelihoods is equal to or larger than the predetermined reference value (threshold value), the acoustic verification section 10F regards the corrected content having been tampered with.

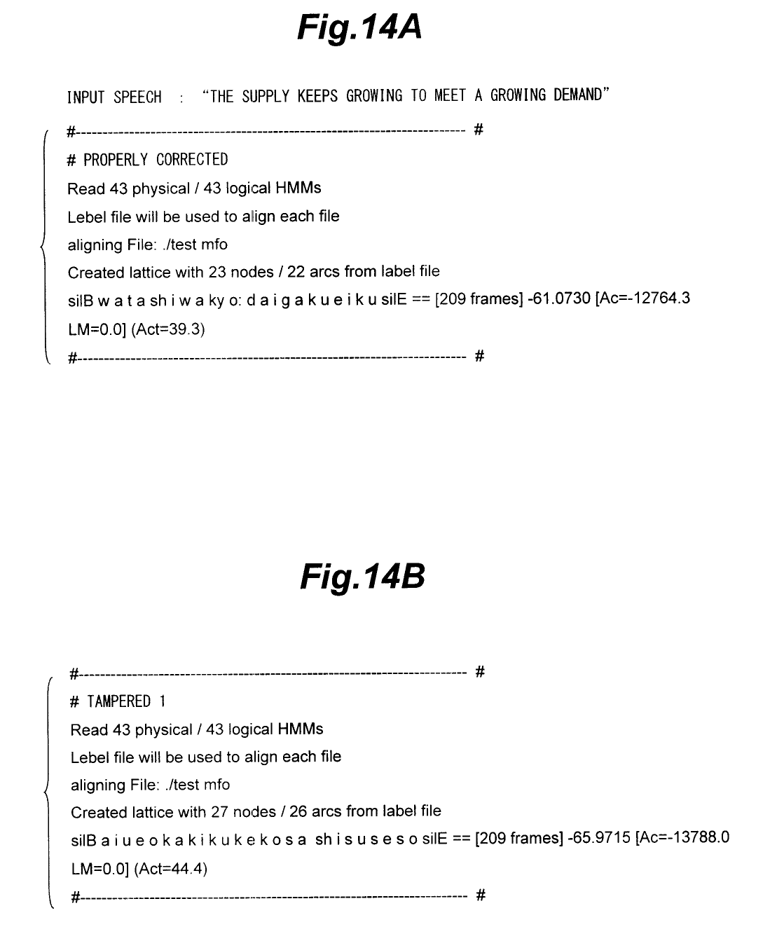

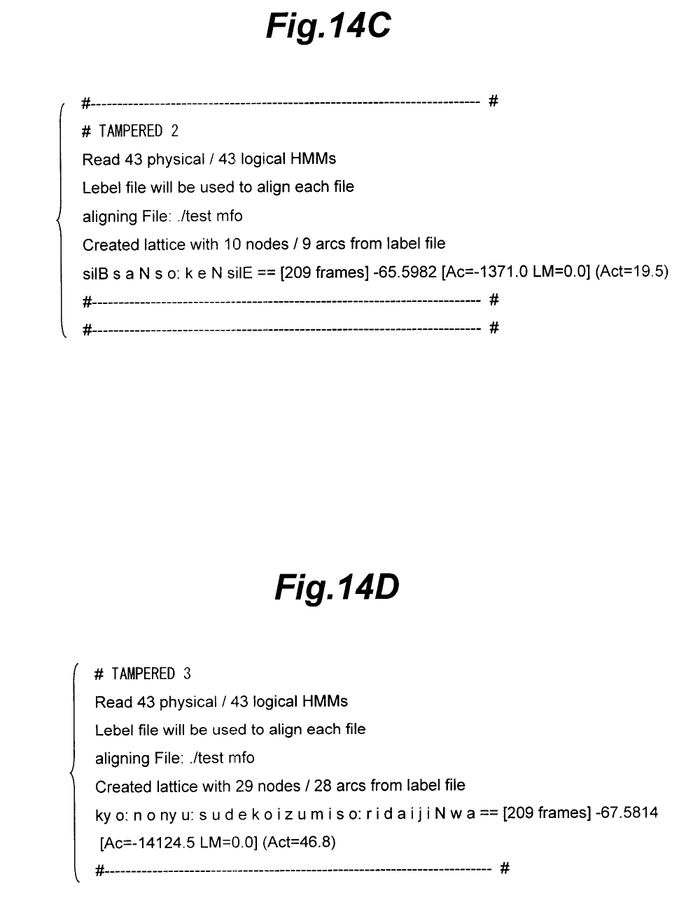

FIG. 14A shows that the acoustic likelihood of a phoneme sequence resulting from conversion of a word sequence which has been obtained as a speech recognition result of an input speech “THE SUPPLY KEEPS GROWING TO MEET A GROWNING DEMAND” is (−61.0730). The acoustic likelihood is obtained by performing Viterbi alignment between the phoneme sequence and a phoneme sequence resulting from conversion of this input speech using the phonetic typewriter. FIG. 14B shows that the acoustic likelihood of a phoneme sequence “ABCABC” is (−65.9715) when the speech recognition result of “THE SUPPLY KEEPS GROWING TO MEET A GROWING DEMAND” has been corrected to the completely different phoneme sequence “ABCABC”. FIG. 14C shows that the acoustic likelihood of a phoneme sequence “TOKYO” is (−65.5982) when the speech recognition result of “THE SUPPLY KEEPS GROWING TO MEET A GROWING DEMAND” has been corrected to the completely different phoneme sequence “TOKYO”. FIG. 14D shows that the acoustic likelihood of a phoneme sequence “BUT OVER THE PAST DECADE THE PRICE OF COCAINE HAS ACTUALLY FALLEN ADJUSTED FOR INFLATION” is (−67.5814) when the speech recognition result of “THE SUPPLY KEEPS GROWING TO MEET A GROWING DEMAND” has been corrected to the completely different phoneme sequence “BUT OVER THE PAST DECADE THE PRICE OF COCAINE HAS ACTUALLY FALLEN ADJUSTED FOR INFLATION”. Tampering illustrated in each of FIGS. 14B through 14D is determined as such, a difference between the acoustic likelihood (−61.0730) in the case of FIG. 14A and the acoustic likelihood in the case of the tampering, e.g. (−65.9715) in FIG. 14B is (3.8985) and exceeds the predetermined reference value (threshold value) of 2.

Assume that determination about correction in a text is first made by using the language verification technology and then determination about the correction in only the text that has been determined to be the proper correction without tampering by the language verification technology is made by the acoustic verification technology, as in this embodiment. Then, the accuracy of determining tampering is increased. Further, text data targeted for acoustic verification which is more complicated than language verification may be reduced. Accordingly, determination about correction may be efficiently made.

In both of the cases where the correction determining section 10 is used or not, an identifier determining section 9A may be further provided at the text data correcting section 9. The identifier determining section 9A determines whether or not identifier accompanying the correction result registration request matches identifier registered in advance. In this case, and the text data correcting section corrects the text data, if the identifier determining section 9A receives only the correction result registration request including the identifier that has been determined to match the identifier registered in advance by the identifier determining section. With this arrangement, only the user having the identifier may correct the text data. Correction that may be maliciously made may be greatly reduced.

A correction allowable range determining section 9B maybe further provided at the text data correcting section 9. The correction allowable range determining section 9B determines a correction allowable range within which correction is allowed, based on identifier accompanying the correction result registration request. Then, the text data correcting section corrects the text data, if the correction allowable range determining section 9B receives only the correction result registration request with the range determined by the correction allowable range determining section Specifically, reliability of the user who has transmitted the correction result registration request is determined from the identifier. Then, weighting for accepting the correction is changed according to the reliability. The correction allowable range maybe thereby changed according to another newly-provided information. With this arrangement, correction by the user may be efficiently utilized as much as possible.

In the embodiment described above, a ranking calculating section 7A may be further provided at the text data storage section 7 in order to promote interest of the user in correction. The ranking calculating section 7A calculates ranking of text data frequently corrected by the text data correcting section 9 and transmits a result of the calculation to one of the user terminal devices in response to a request from the user terminal device.

As the acoustic model used in acoustic recognition a triphone model trained from a common speech corpus such as the Corpus of Spontaneous Japanese (CSJ) maybe employed. However, podcasts may include music and noises in their backgrounds as well as speeches. In order to cope with such a situation where speech recognition is difficult, a noise reduction approach represented by ETSIAdvancedFront-End [ETSIES202050v1.1.1STQ; distibutedspeechrecognition; advancedfront-endfeatureextractionalgorithm; compressionalgorithms. 2002.] should be used to conduct acoustic analysis of a training and recognition preprocess. Performance may be thereby improved.

In this embodiment, a 60000-word bigram trained from a newspaper article text from 1991 to 2002 from among CSRC Software of 2003 version [described in Kawahara, Takeda, Ito, Ri, Shikano, and Yamada, “Overview of Activities and Software of Continuous Speech Recognition Consortium” (IEIC Technical Report, SP2003-169, 2003] was used for the language model. A lot of podcasts, however, include recent topics and vocabularies, and it is therefore difficult to recognize speeches including the recent topics and vocabularies due to a difference from trained data. Then, texts on a Web news site that are updated daily were used for training the language model, thereby improving performance of the language model. Specifically, texts of articles carried on Google news and Yahoo! News, which are comprehensive news sites in Japanese, were daily collected and used for training.

A result of correction by the user using the correcting function may be used in various manners in order to improve speech recognition performance. Correct texts (transcriptions) of overall speech data, for example, may be obtained. Thus, when the acoustic model and the language model are trained again by a common speech recognition method, improvement in the performance may be expected. It can be seen to which correct word an utterance segment that had been recognized erroneously by one of the speech recognizers has been corrected, for example. Thus, when an actual utterance (pronunciation sequence) in that segment can be estimated, a correspondence with the correct word may be obtained. Generally, speech recognition is performed using a dictionary including a pronunciation sequence for each word registered in advance. A speech in an actual environment, however, may include a variation in pronunciation that is difficult to be predicted. This variation does not match with the pronunciation sequence in the dictionary, thereby causing erroneous recognition. Against this backdrop, the pronunciation sequence (phoneme sequence) in the utterance segment in which has been recognized erroneously is automatically estimated by the phonetic typewriter (special speech recognizer that performs speech recognition for each phoneme), and a correspondence between the actual pronunciation sequence and a correct word is additionally registered in the dictionary. With this arrangement, the dictionary may be appropriately referred to for an utterance (pronunciation sequence) that has been varied in the same manner. It may be therefore expected that the same erroneous recognition will not be caused again. Further, a word (unknown word) that had not been registered in the dictionary in advance but has been obtained by typing and correcting by the user may also be recognized.

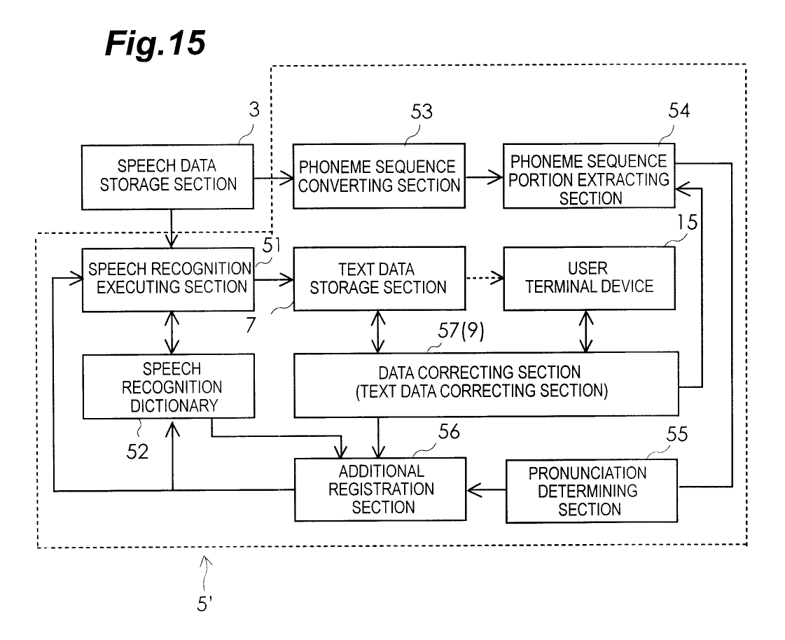

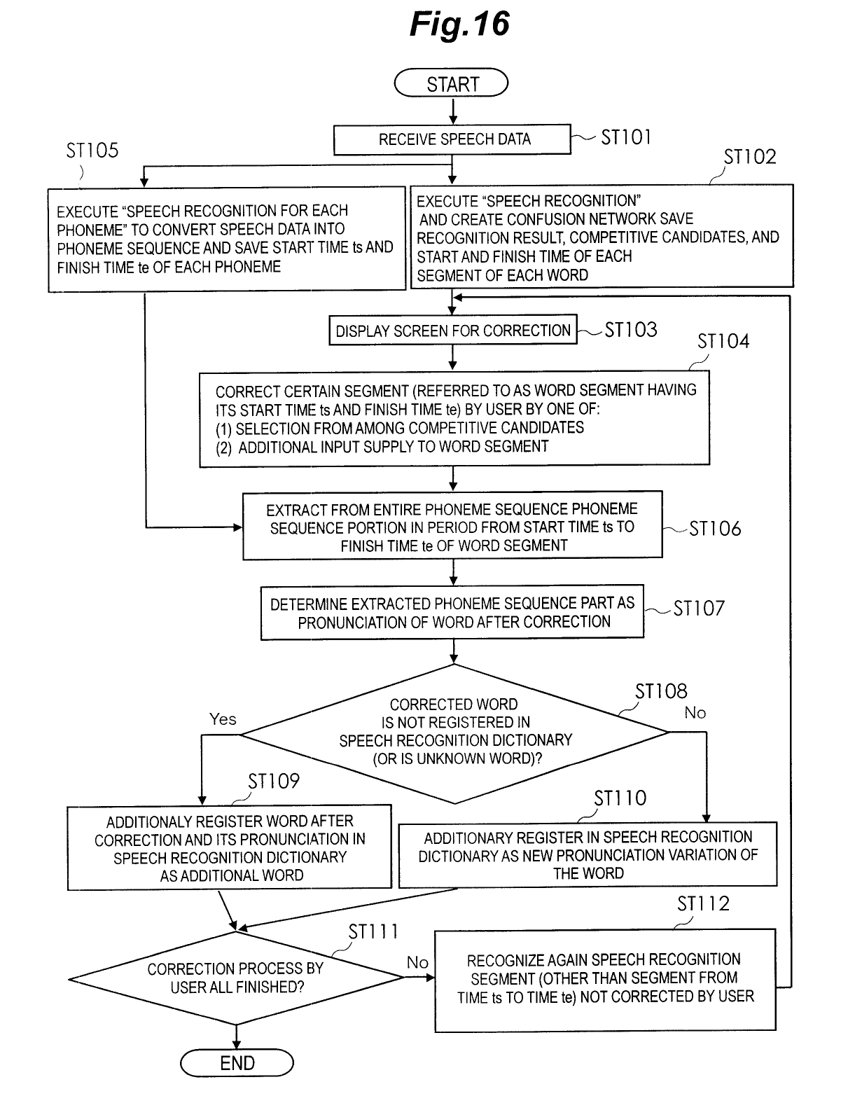

FIG. 15 is a diagram for explaining a configuration of a speech recognition portion 5′ capable of additionally registering an unknown word and a pronunciation, using a result of correction. Referring to FIG. 15, same reference numerals are assigned to components that are the same as those shown in FIG. 1. This speech recognizer 5′ shows a configuration of another embodiment of a speech recognition system of the present invention comprising a speech recognition executing section 51, a speech recognition dictionary 52, the text data storage section 7, a data correcting section 57, the user terminal device 15, a phoneme sequence converting section 53, a phoneme sequence portion extracting section 54, a pronunciation determining section 55, and an additional registration section 56, in the form of a block diagram. The text data correcting portion 9 serves concurrently as the data correcting portion 57. FIG. 16 is a flowchart showing an example of an algorithm of software used when the embodiment in FIG. 15 is implemented by a computer.

This speech recognizer 5′ comprises the speech recognition executing section 51 that converts speech data into text data, using the speech recognition dictionary 52 formed by collecting a lot of combinations of word pronunciation data each comprising at least one combination of a word and at least one pronunciation constituted from at least one phoneme for the word, and the text data storage section 7 that stores the text data resulting from speech recognition by the speech recognition executing section 51. The phoneme sequence converting section 53 has a function of adding start and finish times of a word segment in the speech data corresponding to each word included in the text data. This function is simultaneously executed when the speech recognition executing section 51 performs speech recognition. As a speech recognition technique, various known speech recognition techniques may be employed. In this embodiment in particular, the speech recognition executing section 51 is employed, which has a function of adding to the text data for displaying competitive candidates that compete with words in the text data obtained by speech recognition.

As described before, the data correcting section 57 that is also operated as the text data correcting section 9 presents one or more competitive words for each word in the text data. The text data is obtained from the speech recognition executing section 51, stored in the text data storage portion 7, and then displayed on the user terminal device 15. Then, when a correct word is present in the one or more competitive words, the data correcting section 57 allows correction by selection of the correct word from the one or more competitive words. When the correct word is not present, the data correcting section 57 allows correction of a word targeted for the correction by manual input.

Specifically, a large vocabulary continuous speech recognizer, which was applied for patent in 2004 by inventors of the present invention and has been already disclosed as Japanese Patent Publication No. 2006-146008 is employed for the speech recognition technique used in the speech recognition executing section 51 and a word correction technique used in the data correcting section 57. The large vocabulary continuous speech recognizer has a function capable of generating competitive candidates with confidence scores (confusion network). This speech recognizer presents the candidates to make correction. Details of the data correcting section 57 are already described in Japanese Patent Publication No. 2006-146008. Thus, a description of the data correcting section 57 will be omitted.

The phoneme sequence converting section 53 recognizes the speech data obtained from the speech data storage section 3 in unites of phoneme and converts the recognized speech data into a phoneme sequence composed of a plurality of phonemes. The phoneme sequence converting section 53 has a function of adding to the phoneme sequence a start and a finish time of each phoneme unit in the speech data corresponding to each phoneme included in the phoneme sequence. As the phoneme sequence converting section 53, a known phonetic typewriter may be employed.

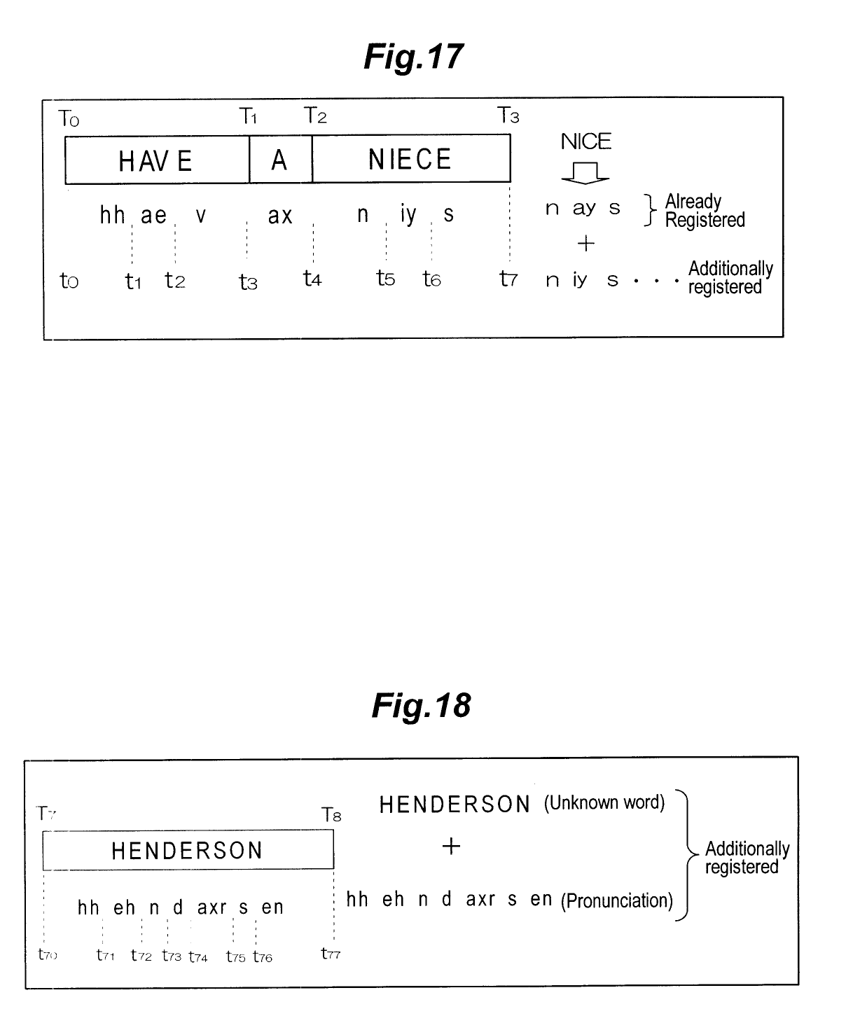

FIG. 17 is a diagram for explaining an example of additional registration of a pronunciation, which will be described later. A phoneme sequence “hh ae v ax n iy s” written in FIG. 17 shows a result of conversion of phoneme data into the phoneme sequence by the phonetic typewriter. Reference characters t₀ to t₇ below the phoneme sequence “hh ae v ax n iy s” indicate start and/or finish times for each phoneme. To be more specific, the start time of the first phoneme “hh” is t₀, while the finish time of the first phoneme “hh” is t₁.

The phoneme sequence portion extracting section 54 extracts from the phoneme sequence a phoneme sequence portion composed of at least one phoneme existing in a segment corresponding to the word segment of the word corrected by the data correcting section 57. The segment extends from the start time to the finish time of the word. Referring to the example in FIG. 17, the corrected word is “NIECE”. The start time of the word segment of “NIECE” is T₂ above the characters of “NIECE”, and the finish time of the word segment of “NIECE” is T₃. Then, the phoneme sequence portion that is present in the word segment of this “NIECE” is “n iy s”. Accordingly, the phoneme sequence portion extracting section 54 extracts from the phoneme sequence the phoneme sequence portion “n iy s” that indicates the pronunciation of the word “NIECE” that has been corrected. In the example in FIG. 17, the word “NIECE” is corrected to a word “NICE” by the data correcting section 57.

The pronunciation determining section 55 determines this phoneme sequence portion “n iy s” as a pronunciation of the word corrected by the data correcting section 57.

The additional registration section 56 combines the corrected word with the pronunciation determined by the pronunciation determining section 55 as new pronunciation data and additionally registers the new pronunciation data in the speech recognition dictionary 52, if it is determined that the corrected word has not been registered in the speech recognition dictionary 52. The additional registration section 56 additionally registers the pronunciation determined by the pronunciation determining section 55 in the speech recognition dictionary as another pronunciation of a registered word that has already registered in the speech recognition dictionary, if it is determined that the corrected word is the registered word.

When characters of “HENDERSON” are set to an unknown word obtained by correction by manual input, as shown in FIG. 18, for example, a phoneme sequence portion “hh eh n d axr s en” is determined as the pronunciation for the word “HENDERSON” obtained by the correction. When it is determined that the word “HENDERSON” is the unknown word that is not registered in the speech recognition dictionary 52, the additional registration section 56 registers the word “HENDERSON” and the pronunciation “hh eh n d axr s en” for the word “HENDERSON” in the speech recognition dictionary 52. Times T₇ to T₈ in the word segment and times t₇₀ to t₇₇ in the phoneme sequence are used in order to associate the word after the correction with the pronunciation. According to this embodiment, an unknown word may be registered in this manner. Thus, the more corrections about unknown words are made, the more the number of unknown word registrations in the speech recognition dictionary 52 is increased, thereby increasing the accuracy of speech recognition. When the word “NIECE” targeted for the correction is corrected to the already registered word “NICE” as shown in FIG. 17, the phoneme sequence portion “n iy s” is registered in the speech recognition dictionary 52 as another pronunciation of the word “NICE”. In other words, as shown in FIG. 17, when a phoneme sequence portion “n ay s” is already registered in the speech recognition dictionary 52 as a pronunciation for the word “NICE”, the phoneme sequence portion “n iy s” is registered in the speech recognition dictionary 52. Times T₂ to T₃ in the word segment and times t₄ to t₇ in the phoneme sequence are used to associate the already registered word with the variation of pronunciation (another pronunciation). With this arrangement, when speech recognition is performed again after the correction and when a speech of the same pronunciation “n iy s” is input again, the speech “n iy s” may undergo speech recognition to produce the word “NICE”. As a result, according to the present invention, a correction result of text data obtained by speech recognition may be utilized for increasing the accuracy of the speech recognition dictionary 52. Accordingly, the accuracy of speech recognition may be increased more than with a conventional speech recognition technique.

Preferably, before correction of text data is completed, an uncorrected portion undergoes the speech recognition again using an unknown word or a pronunciation newly added to the speech recognition dictionary 52. Preferably, the speech recognition section 5′ is configured to perform again speech recognition of speech data corresponding to an uncorrected portion in the text data that has not been corrected yet whenever the additional registration section 56 performs additional registration. With this arrangement, immediately after additional registration is performed in the speech recognition dictionary 52, speech recognition is updated. Then, additional registration may be thereby immediately reflected on the speech recognition. As a result, the accuracy of speech recognition of an uncorrected portion is immediately increased. The number of portions to be modified in the text data may be thereby reduced.

The algorithm shown in FIG. 16 is written assuming the following case as an example. That is, the case is assumed where this embodiment is applied when speech data obtained from a Web is stored in the speech data storage section 3, the speech data is converted into text data by speech recognition, and then the text data is corrected according to a correction command from a common user terminal device. Accordingly, in this example, a correction input section of the data correcting section 57 is the user terminal device. The correction may be of course made by a system manager rather than a user. In this case, the entire data correcting section 57 including the correction input section is present in the system. In the algorithm in FIG. 16, first, speech data is received in step ST101. In step ST102, speech recognition is executed. Then, a confusion network is created in order to obtain competitive candidates for subsequent correction. Since the confusion network is described in detail in Japanese Patent Publication No. 2006-146008, a description of the confusion network will be omitted. In step ST102, a recognition result and the competitive candidates are saved, and start and finish times of a word segment for each word are saved. Then, in step ST103, a screen (interface) for correction is displayed. Next, in step ST104, an operation of the correction is performed. In step ST104, the user prepares a correction request to correct the word segment using the terminal device. Content of the correction request is (1) a request to make selection from among the competitive candidates or (2) a request to additionally supply a word to the word segment. When preparation of the correction request is completed, the user transmits the correction request to the data correcting section 57 in the speech recognition portion 5′ from the user terminal device 15. The data correcting section 57 then executes this request.

In step ST105, the speech data is converted into a phoneme sequence using the phonetic typewriter, in parallel with the steps from step ST102 to step ST104. In other words, “speech recognition for each phoneme” is performed. At this point, start and finish times of each phoneme are also saved together with a result of the speech recognition. Then, in step ST106, a phoneme sequence portion in a period corresponding to the word segment of a word to be corrected (period from a start time is to a finish time to of the word segment) is extracted from the entire phoneme sequence.

In step ST107, the extracted phoneme sequence portion is determined as the pronunciation of a word after the correction. Then, the operation proceeds to step ST108, where it is determined whether or not the word after the correction is registered in the speech recognition dictionary 52 (or whether or not the word is an unknown word). When it is determined that the word after the correction is the unknown word, the operation proceeds to step ST109, and the word after the correction and the pronunciation are registered in the speech recognition dictionary 52 as art additional word. When it is determined that the word after the correction is not an unknown word and is an already registered word, the operation proceeds to step ST110. In step ST110, the pronunciation determined in step ST107 is additionally registered in the speech recognition dictionary 32 as a new pronunciation variation.

Then, when the additional registration is completed, it is determined in step ST111 whether or not the correction process by the user has all been finished, in other words, there is an uncorrected speech recognition segment. When no uncorrected speech recognition segment is left, the operation is finished. When there is the uncorrected speech recognition segment, the operation proceeds to step ST112, where speech recognition of the uncorrected speech recognition segment is performed again. Then, the operation returns to step ST103 again.

A result of correction by the user in accordance with the algorithm in FIG. 16 may be utilized in various manners in order to improve speech recognition performance. Correct texts (transcriptions) of overall speech data, for example, may be obtained. Accordingly, when the acoustic model and the language model are trained again using a common speech recognition method, improvement in the performance may be expected. In this embodiment, it can be seen to which correct word an utterance segment that had been recognized erroneously by one of the speech recognizers has been corrected, for example. Thus, an actual utterance (pronunciation sequence) in that segment is estimated, thereby obtaining a correspondence between the actual utterance and the correct word. Generally, speech recognition is performed using a dictionary including a pronunciation sequence for each word registered in advance. A speech in an actual environment, however, may include a variation in pronunciation that is difficult to be predicted. This variation does not match with the pronunciation sequence in the dictionary, thereby causing erroneous recognition. Then, in this embodiment, the pronunciation sequence (phoneme sequence) in the utterance segment (word segment) of which the erroneous recognition has been caused is automatically estimated by the phonetic typewriter (special speech recognizer that performs speech recognition for each phoneme), and a correspondence between the actual pronunciation sequence and the correct word is additionally registered in the dictionary. With this arrangement, the dictionary may be appropriately referred to for an utterance (pronunciation sequence) that has been varied in the same manner. It may be therefore expected that the same erroneous recognition will not be caused again. Further, a word (unknown word) that had not been registered in the dictionary in advance but has been obtained by typing and correcting by the user may also be recognized.

When the speech recognizer having the additional function described above is used, the text data storage section 7 that stores a plurality of special text data may be employed. Browsing, retrieval, and correction of the special text data are permitted for only the user terminal device that transmits identifier registered in advance. Then, the text data correcting section 7 having a function of permitting the correction of the special text data in response to only a request from the user terminal device that transmits the identifier registered in advance is employed. The retrieval section 13 having a function of permitting the retrieval of the special text data in response to only the request from the user terminal device that transmits the identifier registered in advance is employed. Then, the browsing section 14 having a function of permitting the browsing of the special text data in response to only the request from the user terminal device that transmits the identifier registered in advance is employed. With this arrangement, when correction of the special text data is permitted to a specific user alone, speech recognition may be performed by using the speech recognition dictionary that has achieved the higher accuracy through correction by the common user. An advantage is obtained that the speech recognition system having high accuracy may be secretly provided to the specific user alone.

In the embodiment shown in FIG. 1, the text data correcting section 9 may be configured to correct the text data stored in the text data storage section according to the correction result registration request so that when the text data is displayed on the user terminal device 15, the display may be made in an indication capable of distinguishing between corrected and uncorrected words. For example, distinguishment between the corrected and uncorrected word may be made by using colors which are different between the corrected and uncorrected words. Alternatively, the distinguishment between the corrected and uncorrected words may be made by using typefaces which are different between the corrected and uncorrected words. With this arrangement, the corrected and uncorrected words may be checked at glance. An operation of correction is therefore facilitated. Further, suspension of the correction may also be checked.

In the embodiment shown in FIG. 1, the speech recognition section 5 may be configured as having a function of adding to the text data the data for displaying the competitive candidates so that when the text data is displayed on the user terminal device, the display may be made in an indication capable of distinguishing between words having the competitive candidates and words having no competitive candidates. In this case, by changing brightness or chrominance of the words having the competitive candidates, for example, it may be clearly demonstrated that the words have the competitive candidates. A confidence score determined by the number of competitive candidates may be of course displayed using a brightness or chrominance difference among the words.

### INDUSTRIAL APPLICABILITY

According to the present invention, text data obtained by conversion of speech data using the speech recognition technique is published in the correctable state. Then, correction of the text data is allowed according to the correction result registration request from the user terminal device. Thus, words in the text data resulting from conversion of the speech data may be all used as query words. An advantage is obtained that retrieval of the speech data using the search engine is facilitated. Further, according to the present invention, an opportunity to correct a speech recognition error included in the text data may be provided to the common user. Accordingly, even if a large amount of speech data has been converted into text data by speech recognition and has been published, an advantage is obtained that a speech recognition error may be corrected by user cooperation, without spending enormous expense for correction.

1. A speech data retrieving Web site system that allows retrieval of desired speech data from among a plurality of speech data accessible through the Internet, using a text data search engine, comprising:
a speech data collecting section that collects the plurality of speech data and a plurality of related information respectively accompanying the plurality of speech data and including at least URLs, through the Internet;
a speech data storage section that stores the plurality of speech data and the plurality of related information collected by the speech data collecting section;
a speech recognition section that converts the plurality of speech data stored in the speech data storage section into a plurality of text data using a speech recognition technique;
a text data storage section that associates and stores the plurality of related information accompanying the plurality of speech data and the plurality of text data corresponding to the plurality of speech data;
a text data correcting section that corrects the text data stored in the text data storage section according to a correction result registration request supplied through the Internet; and
a text data publishing section that publishes the plurality of text data stored in the text data storage section in a state searchable by the search engine, downloadable together with the plurality of related information corresponding to the plurality of text data, and correctable.

2. The speech data retrieving Web site system according to claim 1, further comprising:
a retrieval section that retrieves from among the plurality of text data stored in the text data storage section at least one of the text data that satisfies a predetermined condition, based on a query word supplied from a user terminal device through the Internet, and transmits to the user terminal device at least a portion of the one or more text data obtained by the retrieval and one or more related information accompanying the one or more text data.

3. The speech data retrieving Web site system according to claim 1, wherein
the speech recognition section has a function of adding to the text data data for displaying competitive candidates that compete with words in the text data; and
the speech data retrieving Web site system further comprises:
a retrieval section that retrieves from among the plurality of text data and the competitive candidates stored in the text data storage section the at least one of the text data that satisfies a predetermined condition, based on a query word supplied from a user terminal device through the Internet, and transmits to the user terminal device at least a portion of the one or more text data obtained by the retrieval and one or more related information accompanying the one or more text data.

4. The speech data retrieving Web site system according to claim 1, further comprising:
a browsing section that retrieves from among the plurality of text data stored in the text data storage section one of the text data requested for browsing and transmits to a user terminal device at least a portion of the one or more text data obtained by the retrieval, based on a browsing request supplied from the user terminal device through the Internet.

5. The speech data retrieving Web site system according to claim 4, wherein
the speech recognition section has a function of adding to the text data, data for displaying competitive candidates that compute with words in the text data; and
the browsing section has a function of transmitting the text data including the competitive candidates so that the words may be displayed on a display screen of the user terminal device as having the competitive candidates.

6. The speech data retrieving Web site system according to claim 5, wherein
the browsing section has a function of transmitting the text data including the competitive candidates so that the text data including the competitive candidates may be displayed on the display screen of the user terminal device.

7. The speech data retrieving Web site system according to claim 4, wherein
the text data publishing section wholly or partially publishes the text data;
the speech recognition section has a function of including corresponding time information indicating which word included in the text data to which word segment in the speech date corresponds when the speech data is converted into the text data; and
the browsing section has a function of transmitting the text data including the corresponding time information to the user terminal device so that when the speech data is reproduced on a display screen of the user terminal device, a position where the speech data is being reproduced may be displayed on the text data displayed on the display screen of the user terminal device.

8. The speech data retrieving Web site system according to claim 1, wherein
the speech data collecting section is configured to classify the speech data into a plurality of groups according to a genre of speech data content and to store the classified speech data; and
the speech recognition section includes a plurality of speech recognizers corresponding to the plurality of groups, and performs speech recognition of one of the speech data belonging to one of the groups, using one of the speech recognizers corresponding to the one group.

9. The speech data retrieving Web site system according to claim 1, wherein
the speech data collecting section is configured to determine speaker types of the plurality of the speech data, classify the plurality of speech data into the determined speaker types, and store the classified speech data; and
the speech recognition section comprises a plurality of speech recognizers corresponding to the speaker types and performs speech recognition of the speech data belonging to one of the speaker types using the speech recognizers corresponding to the one speaker type.

10. The speech data retrieving Web site system according to claim 1, wherein
the speech recognition section has a function of including corresponding time information indicating which word included in the text data to which word segment in the speech data correspond when the speech data is converted into the text data.

11. The speech data retrieving Web site system according to claim 1, wherein
the speech recognition section has a function of performing speech recognition so that competitive candidates that compete with words in the text data are included in the text data; and
the text data publishing section publishes the plurality of text data including the competitive candidates.

12. The speech data retrieving Web site system according to claim 1, further comprising:
a correction determining section that determines whether or not a corrected content requested by the correction result registration request maybe regarded as a proper correction; and
wherein the text data correcting section reflects only the corrected content that has been regarded as the proper correction by the correction determining section on the correction.

13. The speech data retrieving Web site system according to claim 12, wherein
the correction determining section comprises:
a first sentence score calculator that determines a first sentence score indicating a linguistic likelihood of a corrected word sequence of a predetermined length based on a language model provided in advance, the corrected word sequence including the corrected content requested by the correction result registration request;
a second sentence score calculator that determines a second sentence score indicating a linguistic likelihood of a word sequence of a predetermined length included in the text data, which corresponds to the corrected word sequence and does not include the corrected content, based on the language model provided in advance; and
a language verification section that regards the corrected content to be the proper correction when a difference between the first and second sentence scores is smaller than a predetermined reference value.

14. The speech data retrieving Web site system according to claim 12, wherein
the correction determining section comprises:
a first acoustic likelihood calculator that determines a first acoustic likelihood indicating an acoustic likelihood of a first phoneme sequence based on an acoustic model provided in advance and the speech data, the first phoneme sequence resulting from conversion of a corrected word sequence of a predetermined length including the corrected content requested by the correction result registration request;
a second acoustic likelihood calculator that determines a second acoustic likelihood indicating an acoustic likelihood of a second phoneme sequence based on the acoustic model provided in advance and the speech data, the second phoneme sequence resulting from conversion of a word sequence of a predetermined length included in the text data, which corresponds to the corrected word sequence and does not include the corrected content; and
an acoustic verification section that regards the corrected content to be the proper correction when a difference between the first and second acoustic likelihoods is smaller than a predetermined reference value.

15. The speech data retrieving Web site system according to claim 12, wherein
the correction determining section comprises:
a first sentence score calculator that determines a first sentence score indicating a linguistic likelihood of a corrected word sequence of a predetermined length based on a language model provided in advance, the corrected word sequence including the corrected content requested by the correction result registration request;
a second sentence score calculator that determines a second sentence score indicating a linguistic likelihood of a word sequence of a predetermined length in the text data, which corresponds to the corrected word sequence and does not include the corrected content, based on the language model provided in advance;
a language verification section that regards the corrected content to be the proper correction when a difference between the first and second sentence scores is smaller than a predetermined reference value;
a first acoustic likelihood calculator that determines a first acoustic likelihood based on an acoustic model provided in advance and the speech data, the first acoustic likelihood indicating an acoustic likelihood of a first phoneme sequence resulting from conversion of the corrected word sequence of the predetermined length including the corrected content determined to be the proper correction by the language verification section;
a second acoustic likelihood calculator that determines a second acoustic likelihood indicating an acoustic likelihood of a second phoneme sequence resulting from conversion of the word sequence of the predetermined length included in the text data, which corresponds to the corrected word sequence and does not include the corrected contents, based on the acoustic model set in advance and the speech data; and
an acoustic verification section that finally regards the corrected content to be the proper correction when a difference between the first and second acoustic likelihoods is smaller than a predetermined reference value.

16. The speech data retrieving Web site system according to claim 1, wherein
the text data correcting section further comprises an identifier determining section that determines whether or not identifier accompanying the correction result registration request matches identifier registered in advance, and the text data correcting section corrects the text data, if the identifier determining section receives only the correction result registration request including the identifier that has been determined to match the identifier registered in advance by the identifier determining section.

17. The speech data retrieving Web site system according to claim 1, wherein
the text data correcting section further comprises a correction allowable range determining section that determines a correction allowable range within which the correction is allowed, based on identifier accompanying the correction result registration request, and the text data correcting section corrects the text data if the correction allowable range determining section receives only the correction result registration request with the range determined by the correction allowable range determining section.

18. The speech data retrieving Web site system according to claim 1, further comprising:
a ranking calculating section that calculates ranking of a plurality of the text data frequently corrected by the text data correcting section and transmits a result of the calculation to a user terminal device in response to a request from the user terminal device.

19. The speech data retrieving Web site system according to claim 1, wherein
the speech recognition section has a function of additionally registering an unknown word and a new pronunciation in a built-in speech recognition dictionary, according to the correction by the text data correcting section.

20. The speech data retrieving Web site system according to claim 19, wherein
the text data storage section stores a plurality of special text data which is permitted for only a user terminal device that transmits identifier registered in advance allowed to brow, retrieve and correct; and
the text data correcting section has a function of permitting the correction of the special text data in response to only a request from the user terminal device that transmits the identifier registered in advance, the retrieval section has a function of permitting the retrieval of the special text data in response to only the request from the user terminal device that transmits the identifier registered in advance, and the browsing section has a function of permitting the browsing of the special text data in response to only the request from the user terminal device that transmits the identifier registered in advance.

21. The speech data retrieving Web site system according to claim 19, wherein
the speech recognition section includes:
a speech recognition executing section having a function of converting the speech data into the text data using the speech recognition dictionary having a lot of word pronunciation data each comprising at least one combination of a word and at least one pronunciation constituted from at least one phoneme for the word, and adding to the text data start and finish times of a word segment in the speech data corresponding to each word included in the text data;
a data correcting section configured to present one or more competitive candidates for each word in the text data obtained from the speech recognition executing section, to allow correction of a word targeted for correction by selecting a correct word from among the one or more competitive candidates when there is the correct word among the one or more competitive candidates, and to allow correction of the word targeted for correction by manual input when there is not the correct word among the one or more competitive candidates;
a phoneme sequence converting section having a function of recognizing the speech data in unites of phoneme, thereby converting the recognized speech data into a phoneme sequence composed of a plurality of phonemes, and adding to the phoneme sequence a start time and a finish time of each phoneme unit in the speech data corresponding to each phoneme included in the phoneme sequence;
a phoneme sequence portion extracting section that extracts from the phoneme sequence a phoneme sequence portion composed of at least one phonemes existing in a segment corresponding to a period from the start time to the finish time of the word segment of the word corrected by the data correcting section,
a pronunciation determining section that determines the phoneme sequence portion as a pronunciation of the word corrected by the data correcting section; and
an additional registration section that combines the corrected word with the pronunciation determined by the pronunciation determining section as new pronunciation data and additionally registers the new pronunciation data in the speech recognition dictionary if it is determined that the corrected word has not been registered in the speech recognition dictionary, or additionally registers the pronunciation determined by the pronunciation determining section in the speech recognition dictionary as another pronunciation of a registered word that has already registered in the speech recognition dictionary if it is determined that the corrected word is the registered word.

22. The speech data retrieving Web site system according to claim 1, wherein
the text data correcting section corrects the text data stored in the text data storage section according to the correction result registration request so that when the text data is displayed on a user terminal device, the display may be made in an indication capable of distinguishing between corrected and uncorrected words.

23. The speech data retrieving Web site system according to claim 3, wherein
the speech recognition section has a function of adding to the text data the data for displaying the competitive candidates so that when the text data is displayed on the user terminal device, the display may be made in an indication capable of distinguishing between the words having the competitive candidates and words having no competitive candidates.

24. A recording medium readable by a computer, which records a program for implementation of a speech data retrieving Web site system by the computer, the speech data retrieving Web site system allowing retrieval of desired speech data from among a plurality of speech data accessible through the Internet, using a text data search engine, the program being for causing the computer to function as:
a speech data collecting section that collects the plurality of speech data and a plurality of related information respectively accompanying the plurality of speech data and including at least URLs through the Internet;
a speech data storage section that stores the plurality of speech data and the plurality of related information collected by the speech data collecting section;
a speech recognition section that converts the plurality of speech data stored in the speech data storage section into a plurality of text data using a speech recognition technique;
a text data storage section that associates and stores the plurality of related information accompanying the plurality of speech data and the plurality of text data corresponding to the plurality of speech data;
a text data correcting section that corrects the text data stored in the text data storage section according to a correction result registration request supplied through the Internet; and
a text data publishing section that publishes the plurality of text data stored in the text data storage section in a state searchable by the search engine, downloadable together with the plurality of related information corresponding to the plurality of text data, and correctable.

25. A method of constructing and managing a speech data retrieving Web site system that allows retrieval of desired speech data from among a plurality of speech data accessible through the Internet, using a text data search engine, the method comprising the steps of:
collecting the plurality of speech data and a plurality of related information respectively accompanying the plurality of speech data and including at least URLs through the Internet;
storing the plurality of speech data and the plurality of related information collected by the speech data collecting section in a speech data storage section;
converting the plurality of speech data stored in the speech data storage section into a plurality of text data using a speech recognition technique;
associating and storing in a text data storage section the plurality of related information accompanying the plurality of speech data and the plurality of text data corresponding to the plurality of speech data;
correcting the text data stored in the text data storage section according to a correction result registration request supplied through the Internet; and
publishing the plurality of text data stored in the text data storage section in a state searchable by the search engine, downloadable together with the plurality of related information corresponding to the plurality of text data, and correctable.
